(19) United States
(12) Patent Application Publication
(10) Pub. No.: US 2025/0373822 A1
(43) Pub. Date: Dec. 4, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Na ZHANG, Beijing (CN); Jizheng XU, Los Angeles, CA (US); Kai ZHANG, Los Angeles, CA (US); Li ZHANG, Los Angeles, CA (US)

(21) Appl. No.: 19/298,990

(22) Filed: Aug. 13, 2025

Related U.S. Application Data
(63) Continuation of application No. PCT/CN2024/077020, filed on Feb. 8, 2024.

(30) Foreign Application Priority Data
Feb. 13, 2023 (WO) PCT/CN2023/075743

(51) Int. Cl. H04N 19/176; H04N 19/105; H04N 19/159; H04N 19/513; H04N 19/593

(52) U.S. Cl. CPC H04N 19/176; H04N 19/105; H04N 19/159; H04N 19/521; H04N 19/593

(57) ABSTRACT

Embodiments of the present disclosure provide a solution for video processing. A method for video processing is proposed. In the method, for a conversion between a current video block of a video and a bitstream of the video, a process is applied to the current video block based on template matching. At least one reference sample of a current template of the current video block is determined based on a block vector (BV) of the current video block during the process. The conversion is performed based on the applying.

### CROSS REFERENCE TO RELATED APPLICATIONS

This application is a continuation of International Application No. PCT/CN2024/077020, filed on Feb. 8, 2024, which claims the benefit of International Application No. PCT/CN2023/075743 filed on Feb. 13, 2023. The entire contents of these applications are hereby incorporated by reference in their entireties.

### FIELDS

Embodiments of the present disclosure relates generally to video processing techniques, and more particularly, to intra block copy (IBC) and intra template matching prediction (IntraTMP) prediction.

BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: applying, for a conversion between a current video block of a video and a bitstream of the video, a process to the current video block based on template matching, wherein at least one reference sample of a current template of the current video block is determined based on a block vector (BV) of the current video block during the process; and performing the conversion based on the applying. The method in accordance with the first aspect of the present disclosure applies the template matching process to a block which has a BV. In this way, the coding efficiency and/or coding effectiveness can be improved.

In a second aspect, another method for video processing is proposed. The method comprises: determining, for a conversion between a current video block of a video and a bitstream of the video, a content type of a video unit in the video, the current video block being in the video unit; applying an intra block copy (IBC) merge mode with block vector differences (IBC-MBVD) to the current video block based on the content type; and performing the conversion based on the applying. The method in accordance with the second aspect of the present disclosure enabling different IBC-MBVD design for different content types, such as natural content and screen content. The coding efficiency and/or coding effectiveness can thus be improved.

In a third aspect, another method for video processing is proposed. The method comprises: determining, for a conversion between a current video block of a video and a bitstream of the video, a prediction of the current video block based on at least one first block vector difference (BVD) offset for a first direction and at least one second BVD offset for a second direction, the current video block being coded with an intra block copy (IBC) merge mode with block vector differences (IBC-MBVD), the at least one second BVD offset being different from the at least one first BVD offset, and the first direction being different from the second direction; and performing the conversion based on the prediction. The method in accordance with the third aspect of the present disclosure uses different BVD offsets for different directions in IBC-MBVD prediction. In this way, the coding efficiency and coding effectiveness can be improved.

In a fourth aspect, an apparatus for video processing is proposed. The apparatus comprises a processor and a non-transitory memory with instructions thereon. The instructions upon execution by the processor, cause the processor to perform a method in accordance with the first aspect, the second aspect or the third aspect of the present disclosure.

In a fifth aspect, a non-transitory computer-readable storage medium is proposed. The non-transitory computer-readable storage medium stores instructions that cause a processor to perform a method in accordance with the first aspect, the second aspect or the third aspect of the present disclosure.

In a sixth aspect, another non-transitory computer-readable recording medium is proposed. The non-transitory computer-readable recording medium stores a bitstream of a video which is generated by a method performed by an apparatus for video processing. The method comprises: applying a process to a current video block of the video based on template matching, wherein at least one reference sample of a current template of the current video block is determined based on a block vector (BV) of the current video block during the process; and generating the bitstream based on the applying.

In a seventh aspect, a method for storing a bitstream of a video is proposed. The method comprises: applying a process to a current video block of the video based on template matching, wherein at least one reference sample of a current template of the current video block is determined based on a block vector (BV) of the current video block during the process; generating the bitstream based on the applying; and storing the bitstream in a non-transitory computer-readable recording medium.

In an eighth aspect, another non-transitory computer-readable recording medium is proposed. The non-transitory computer-readable recording medium stores a bitstream of a video which is generated by a method performed by an apparatus for video processing. The method comprises: determining a content type of a video unit in the video, a current video block being in the video unit; applying an intra block copy (IBC) merge mode with block vector differences (IBC-MBVD) to the current video block based on the content type; and generating the bitstream based on the applying.

In a ninth aspect, a method for storing a bitstream of a video is proposed. The method comprises: determining a content type of a video unit in the video, a current video block being in the video unit; applying an intra block copy (IBC) merge mode with block vector differences (IBC-MBVD) to the current video block based on the content type; generating the bitstream based on the applying; and storing the bitstream in a non-transitory computer-readable recording medium.

In a tenth aspect, another non-transitory computer-readable recording medium is proposed. The non-transitory computer-readable recording medium stores a bitstream of a video which is generated by a method performed by an apparatus for video processing. The method comprises: determining a prediction of a current video block of the video based on at least one first block vector difference (BVD) offset for a first direction and at least one second BVD offset for a second direction, the current video block being coded with an intra block copy (IBC) merge mode with block vector differences (IBC-MBVD), the at least one second BVD offset being different from the at least one first BVD offset, and the first direction being different from the second direction; and generating the bitstream based on the prediction.

In an eleventh aspect, a method for storing a bitstream of a video is proposed. The method comprises: determining a prediction of a current video block of the video based on at least one first block vector difference (BVD) offset for a first direction and at least one second BVD offset for a second direction, the current video block being coded with an intra block copy (IBC) merge mode with block vector differences (IBC-MBVD), the at least one second BVD offset being different from the at least one first BVD offset, and the first direction being different from the second direction; generating the bitstream based on the prediction; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates spatial neighboring positions used in IBC vector prediction;

FIG. 5 illustrates current CTU processing order and its available reference samples in current and left CTU;

FIG. 6 illustrates spatial neighboring positions used in IBC merge/AMVP list construction;

FIG. 7 illustrates padding candidates for the replacement of the zero-vector in the IBC list;

FIG. 8 illustrates IBC reference region depending on current CU position;

FIG. 9 illustrates a reference area for IBC when CTU (m,n) is coded;

FIG. 10A illustrates an illustration of BV adjustment for horizontal flip;

FIG. 10B illustrates an illustration of BV adjustment for vertical flip;

FIGS. 11 illustrates an intra template matching search area used;

FIG. 12 illustrates use of IntraTMP block vector for IBC block;

FIG. 13A illustrates an example of IBC block vector candidate list existing only IBC block vectors;

FIG. 13B illustrates an example of IBC block vector candidate list existing both IBC and IntraTMP block vectors;

FIG. 14 illustrates template and reference samples of the template in reference pictures;

FIG. 15 illustrates template and reference samples of the template for block with sub-block motion using the motion information of the subblocks of the current block;

FIG. 16 illustrates the adjacent half-pel positions in 8 directions;

FIG. 17 illustrates template matching cost derivation in BVDSP;

FIG. 18A illustrates an example of offset directions in accordance with embodiments of the present disclosure;

FIG. 18B illustrates another example of offset directions in accordance with embodiments of the present disclosure;

FIG. 18C illustrates a further example of offset directions in accordance with embodiments of the present disclosure;

FIG. 19 illustrates a flowchart of a method for video processing in accordance with embodiments of the present disclosure;

FIG. 20 illustrates a flowchart of a method for video processing in accordance with embodiments of the present disclosure;

FIG. 21 illustrates a flowchart of a method for video processing in accordance with embodiments of the present disclosure;

FIG. 22 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

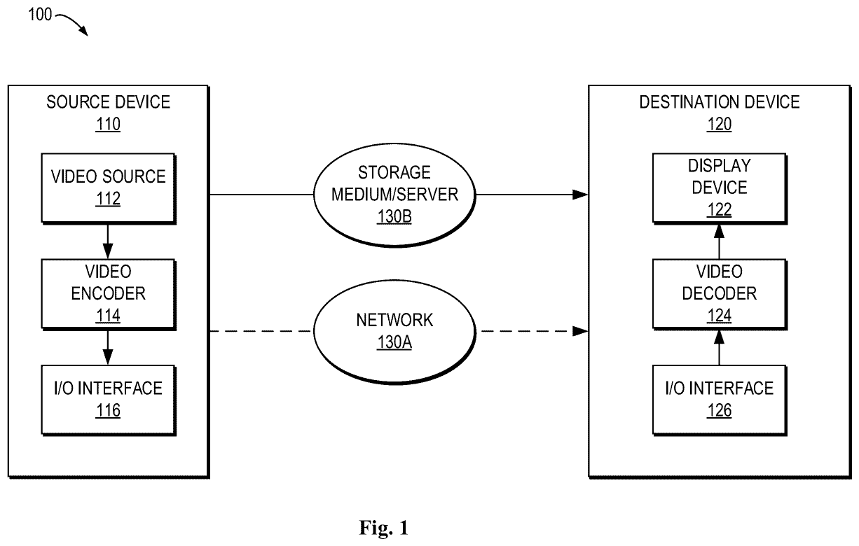

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

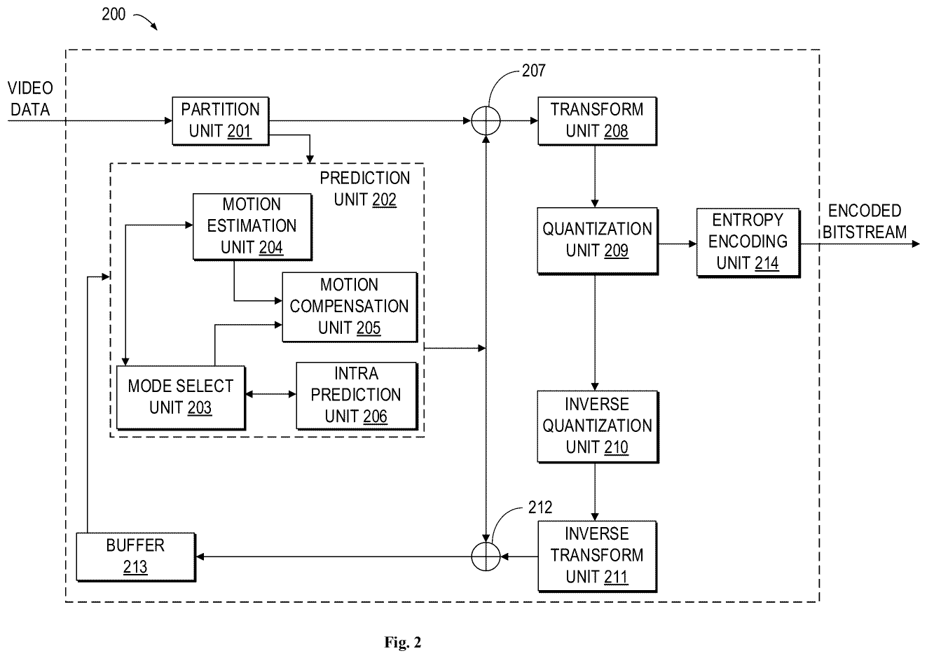

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

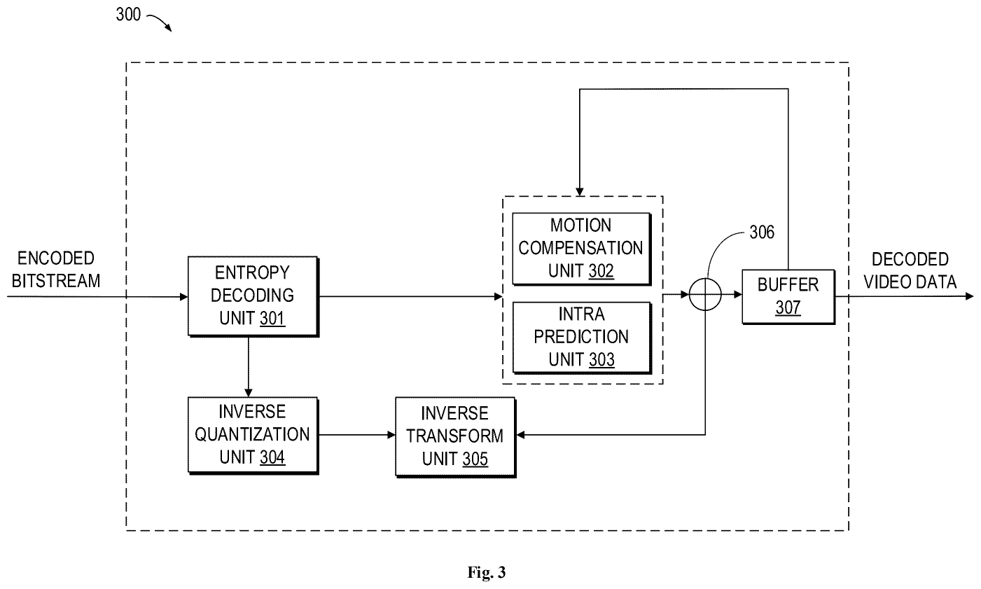

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to image/video coding, especially on IBC and IntraTMP Prediction. It may be applied to the existing video coding standard like HEVC, or the standard VVC (Versatile Video Coding). It may be also applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized.

To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

In January 2021, JVET established an Exploration Experiment (EE), targeting at enhanced compression efficiency beyond VVC capability with novel traditional algorithms. Soon later, ECM was built as the common software base for longer-term exploration work towards the next generation video coding standard.

### 2.1. Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signaled as IBC AMVP mode or IBC skip/merge mode as follows:
IBC skip/merge mode: a merge candidate index is used to indicate which of the block vectors in the list from neighboring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbor and one from above neighbor (if IBC coded). When either neighbor is not available, a default block vector will be used as a predictor. A flag is signaled to indicate the block vector predictor index.

### 2.1.1. Simplification of IBC Vector Prediction

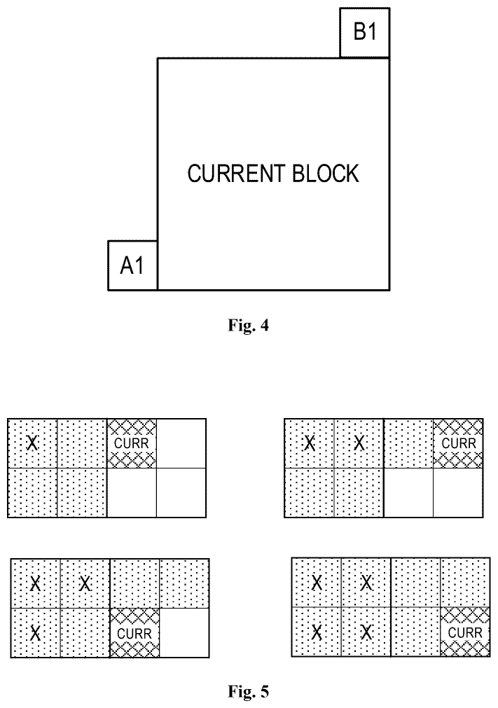

The BV predictors for merge mode and AMVP mode in IBC will share a common predictor list, which consist of the following elements:
2 spatial neighboring positions (A1, B1 as in FIG. 4, which illustrates the spatial neighboring positions used in IBC vector prediction),
5 HMVP entries,
Zero vectors by default.

For merge mode, up to first 6 entries of this list will be used; for AMVP mode, the first 2 entries of this list will be used. And the list conforms with the shared merge list region requirement (shared the same list within the SMR).

### 2.1.2. IBC Reference Region

To reduce memory consumption and decoder complexity, the IBC in VVC allows only the reconstructed portion of the predefined area including the region of current CTU and some region of the left CTU. FIG. 5 illustrates the reference region of IBC Mode, where each block represents 64×64 luma sample unit. FIG. 5 illustrates current CTU processing order and its available reference samples in current and left CTU.

Depending on the location of the current coding CU location within the current CTU, the following applies:
If current block falls into the top-left 64×64 block of the current CTU, then in addition to the already reconstructed samples in the current CTU, it can also refer to the reference samples in the bottom-right 64×64 blocks of the left CTU, using CPR mode. The current block can also refer to the reference samples in the bottom-left 64×64 block of the left CTU and the reference samples in the top-right 64×64 block of the left CTU, using CPR mode.
If current block falls into the top-right 64×64 block of the current CTU, then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.
If current block falls into the bottom-left 64×64 block of the current CTU, then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.
If current block falls into the bottom-right 64×64 block of the current CTU, it can only refer to the already reconstructed samples in the current CTU, using CPR mode.

This restriction allows the IBC mode to be implemented using local on-chip memory for hardware implementations.

2.1.3. IBC Interaction with Other Coding Tools

The interaction between IBC mode and other inter coding tools in VVC, such as pairwise merge candidate, history-based motion vector predictor (HMVP), combined intra/inter prediction mode (CIIP), merge mode with motion vector difference (MMVD), and geometric partitioning mode (GPM) are as follows:
IBC can be used with pairwise merge candidate and HMVP. A new pairwise IBC merge candidate can be generated by averaging two IBC merge candidates. For HMVP, IBC motion is inserted into history buffer for future referencing.
IBC cannot be used in combination with the following inter tools: affine motion, CIIP, MMVD, and GPM.
IBC is not allowed for the chroma coding blocks when DUAL_TREE partition is used.

Unlike in the HEVC screen content coding extension, the current picture is no longer included as one of the reference pictures in the reference picture list 0 for IBC prediction. The derivation process of motion vectors for IBC mode excludes all neighboring blocks in inter mode and vice versa. The following IBC design aspects are applied:
IBC shares the same process as in regular MV merge including with pairwise merge candidate and history-based motion predictor, but disallows TMVP and zero vector because they are invalid for IBC mode.
Separate HMVP buffer (5 candidates each) is used for conventional MV and IBC.
Block vector constraints are implemented in the form of bitstream conformance constraint, the encoder needs to ensure that no invalid vectors are present in the bitstream, and merge shall not be used if the merge candidate is invalid (out of range or 0). Such bitstream conformance constraint is expressed in terms of a virtual buffer as described below.
For deblocking, IBC is handled as inter mode.
If the current block is coded using IBC prediction mode, AMVR does not use quarter-pel; instead, AMVR is signaled to only indicate whether MV is inter-pel or 4 integer-pel.
The number of IBC merge candidates can be signalled in the slice header separately from the numbers of regular, subblock, and geometric merge candidates.

A virtual buffer concept is used to describe the allowable reference region for IBC prediction mode and valid block vectors. Denote CTU size as ctbSize, the virtual buffer, ibcBuf, has width being wIbcBuf=128×128/ctbSize and height hIbcBuf=ctbSize. For example, for a CTU size of 128×128, the size of ibcBuf is also 128×128; for a CTU size of 64×64, the size of ibcBuf is 256×64; and a CTU size of 32×32, the size of ibcBuf is 512×32.

The size of a VPDU is min(ctbSize, 64) in each dimension, Wᵥ=min(ctbSize, 64). The virtual IBC buffer, ibcBuf is maintained as follows.
At the beginning of decoding each CTU row, refresh the whole ibcBuf with an invalid value −1.
At the beginning of decoding a VPDU (xVPDU, yVPDU) relative to the top-left corner of the picture, set the ibcBuf[x][y]=−1, with x=xVPDU % wIbcBuf, . . . , xVPDU % wIbcBuf+Wᵥ−1; y=yVPDU % ctbSize, . . . , yVPDU % ctbSize+Wᵥ−1.
After decoding a CU contains (x, y) relative to the top-left corner of the picture, set ibcBuf[x % wIbcBuf][y % ctbSize]=recSample[x][y]

For a block covering the coordinates (x, y), if the following is true for a block vector bv=(bv[0], bv[1]), then it is valid; otherwise, it is not valid:

$$ibcBuf [ ( x + bv [ 0 ] ) \% wIbcBuf ] [ ( y + bv [ 1 ] ) \% ctbSize ] shall not be equal to - 1.$$

### 2.1.4. IBC Virtual Buffer Test

A luma block vector bvL (the luma block vector in 1/16 fractional-sample accuracy) shall obey the following constraints:
CtbSizeY is greater than or equal to ((yCb+(bvL[1]>>4)) & (CtbSizeY−1))+cbHeight.
IbcVirBuf[0][(x+(bvL[0]>>4)) & (IbcBufWidthY−1)][(y+(bvL[1]>>4)) & (CtbSizeY−1)] shall not be equal to −1 for x=xCb . . . xCb+cbWidth−1 and y=yCb . . . yCb+cbHeight−1.

Otherwise, bvL is considered as an invalid bv.

The samples are processed in units of CTBs. The array size for each luma CTB in both width and height is CtbSizeY in units of samples.
(xCb, yCb) is a luma location of the top-left sample of the current luma coding block relative to the top-left luma sample of the current picture,
cbWidth specifies the width of the current coding block in luma samples,
cbHeight specifies the height of the current coding block in luma samples.

### 2.2. IBC Merge/AMVP List Construction

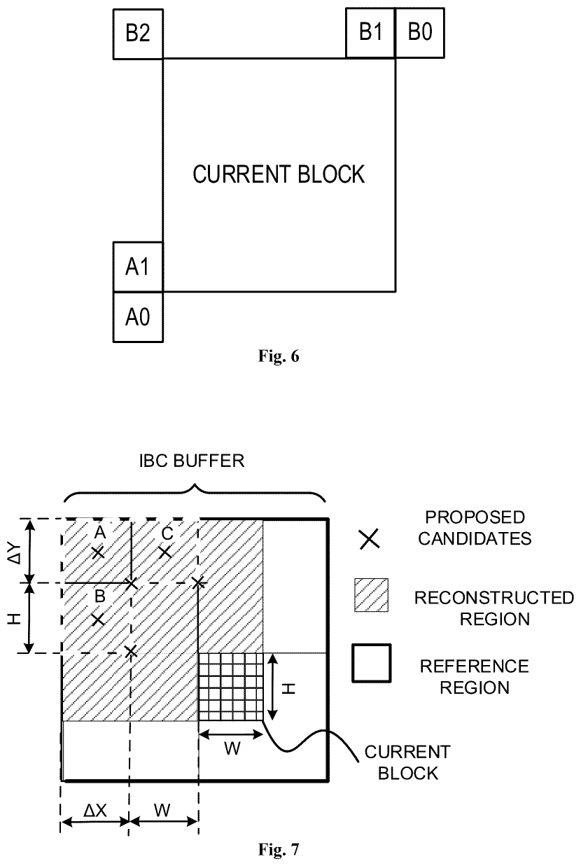

The IBC merge/AMVP list construction is modified as follows:
Only if an IBC merge/AMVP candidate is valid, it can be inserted into the IBC merge/AMVP candidate list.
Above-right, bottom-left, and above-left spatial candidates (B0, A0, and B2 as shown in FIG. 6, which illustrates spatial neighboring positions used in IBC merge/AMVP list construction), and one pairwise average candidate can be added into the IBC merge/AMVP candidate list.
Template based adaptive reordering (ARMC-TM) is applied to IBC merge list.

The HMVP table size for IBC is increased to 25. After up to 20 IBC merge candidates are derived with full pruning, they are reordered together. After reordering, the first 6 candidates with the lowest template matching costs are selected as the final candidates in the IBC merge list.

The zero vectors' candidates to pad the IBC Merge/AMVP list are replaced with a set of BVP candidates located in the IBC reference region. A zero vector is invalid as a block vector in IBC merge mode, and consequently, it is discarded as BVP in the IBC candidate list.

Three candidates are located on the nearest corners of the reference region, and three additional candidates are determined in the middle of the three sub-regions (A, B, and C), whose coordinates are determined by the width, and height of the current block and the ΔX and ΔY parameters, as is depicted in FIG. 7, which illustrates padding candidates for the replacement of the zero-vector in the IBC list.

2.3. IBC with Template Matching

Template Matching is used in IBC for both IBC merge mode and IBC AMVP mode.

The IBC-TM merge list is modified compared to the one used by regular IBC merge mode such that the candidates are selected according to a pruning method with a motion distance between the candidates as in the regular TM merge mode. The ending zero motion fulfillment is replaced by motion vectors to the left (−W, 0), top (0, −H) and top-left (−W, −H), where W is the width and H the height of the current CU.

In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to 3 candidates are selected from the IBC-TM merge list. Each of those 3 selected candidates are refined using the Template Matching method and sorted according to their resulting Template Matching cost. Only the 2 first ones are then considered in the motion estimation process as usual.

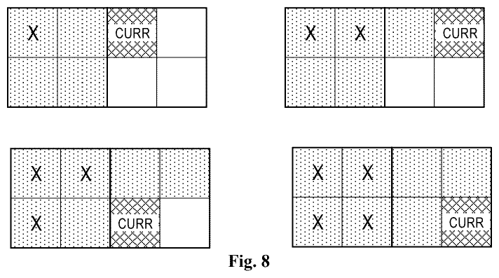

The Template Matching refinement for both IBC-TM merge and AMVP modes is quite simple since IBC motion vectors are constrained (i) to be integer and (ii) within a reference region as shown in FIG. 8, which illustrates IBC reference region depending on current CU position. So, in IBC-TM merge mode, all refinements are performed at integer precision, and in IBC-TM AMVP mode, they are performed either at integer or 4-pel precision depending on the AMVR value. Such a refinement accesses only to samples without interpolation. In both cases, the refined motion vectors and the used template in each refinement step must respect the constraint of the reference region.

### 2.4. IBC Reference Area

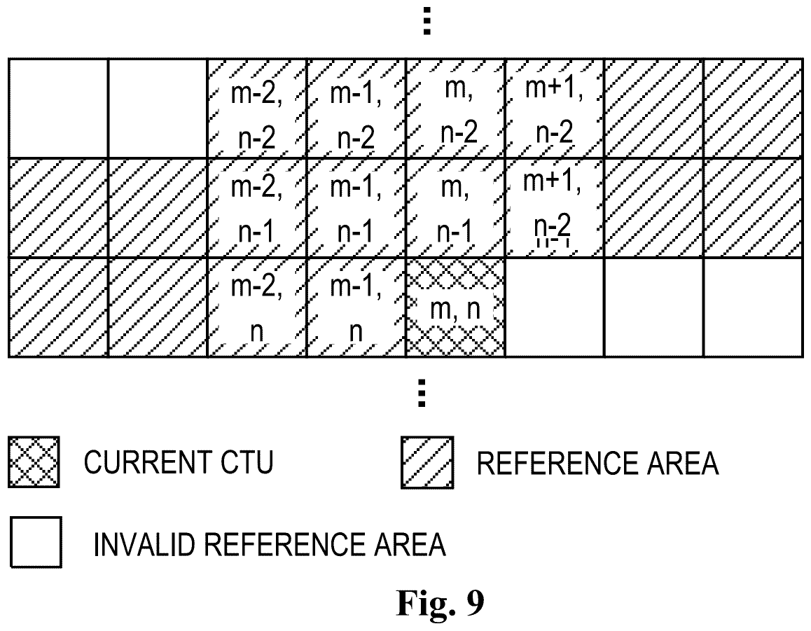

The reference area for IBC is extended to two CTU rows above. FIG. 9 illustrates the reference area for coding CTU (m,n). Specifically, for CTU (m,n) to be coded, the reference area includes CTUs with index (m−2,n—2) . . . (W,n−2), (0,n−1) . . . (W,n−1),(0,n) . . . (m,n), where W denotes the maximum horizontal index within the current tile, slice or picture. When CTU size is 256, the reference area is limited to one CTU row above. This setting ensure that for CTU size being 128 or 256, IBC does not require extra memory in the current ETM platform. The per-sample block vector search (or called local search) range is limited to [−(C<<1), C>>2] horizontally and [−C, C>>2] vertically to adapt to the reference area extension, where C denotes the CTU size.

### 2.5. Reconstruction-Reordered IBC (RR-IBC)

A Reconstruction-Reordered IBC (RR-IBC) mode is allowed for IBC coded blocks. When RR-IBC is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.

Two flip methods, horizontal flip and vertical flip, are supported for RR-IBC coded blocks. A syntax flag is firstly signalled for an IBC AMVP coded block, indicating whether the reconstruction is flipped, and if it is flipped, another flag is further signaled specifying the flip type. For IBC merge, the flip type is inherited from neighbouring blocks, without syntax signalling. Considering the horizontal or vertical symmetry, the current block and the reference block are normally aligned horizontally or vertically. Therefore, when a horizontal flip is applied, the vertical component of the BV is not signaled and inferred to be equal to 0. Similarly, the horizontal component of the BV is not signaled and inferred to be equal to 0 when a vertical flip is applied.

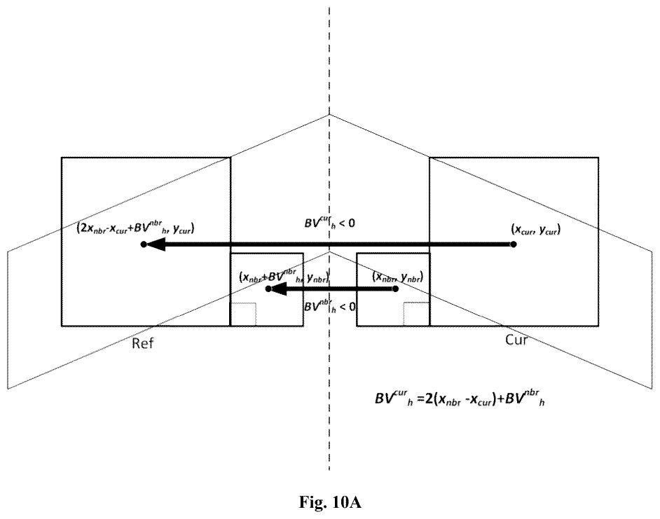

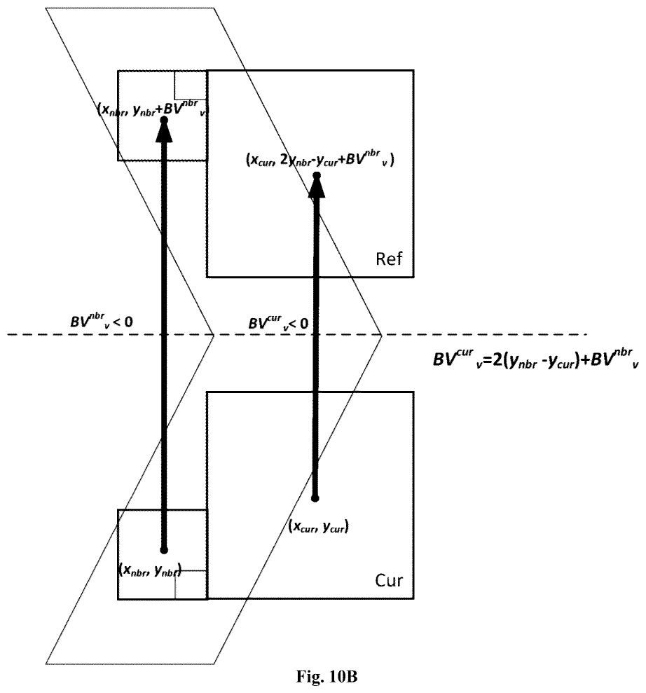

FIG. 10A illustrates an illustration of BV adjustment for horizontal flip. FIG. 10B illustrates an illustration of BV adjustment for vertical flip.

To better utilize the symmetry property, a flip-aware BV adjustment approach is applied to refine the block vector candidate. For example, as shown in FIG. 10A and FIG. 10B, (x_{nbr}, y_{nbr}) and (x_{cur}, y_{cur}) represent the coordinates of the center sample of the neighbouring block and the current block, respectively, BV^{nbr} and BV^{nbr} denotes the BV of the neighbouring block and the current block, respectively. Instead of directly inheriting the BV from a neighbouring block, the horizontal component of BV^{cur} is calculated by adding a motion shift to the horizontal component of BV^{nbr} (denoted as BV^{nbr}ₕ) in case that the neighbouring block is coded with a horizontal flip, i.e., BV^{cur}ₕ=2(x_{nbr}−x_{cur})+BV^{nbr}ₕ. Similarly, the vertical component of BV^{cur} is calculated by adding a motion shift to the vertical component of BV^{nbr} (denoted as BV^{nbr}ᵥ) in case that the neighbouring block is coded with a vertical flip, i.e., BV^{cur}ᵥ=2(y_{nbr}−y_{cur})+BV^{nbr}ᵥ.

2.6. IBC Merge Mode with Block Vector Differences (IBC-MBVD)

Affine-MMVD and GPM-MMVD have been adopted to ECM as an extension of regular MMVD mode. It is natural to extend the MMVD mode to the IBC merge mode.

In IBC-MBVD, the distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

The base candidates are selected from the first five candidates in the reordered IBC merge list. And based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding. The MBVD index is binarized by the rice code with the parameter equal to 1.

An IBC-MBVD coded block does not inherit flip type from a RR-IBC coded neighbor block.

### 2.7. Intra Template Matching

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

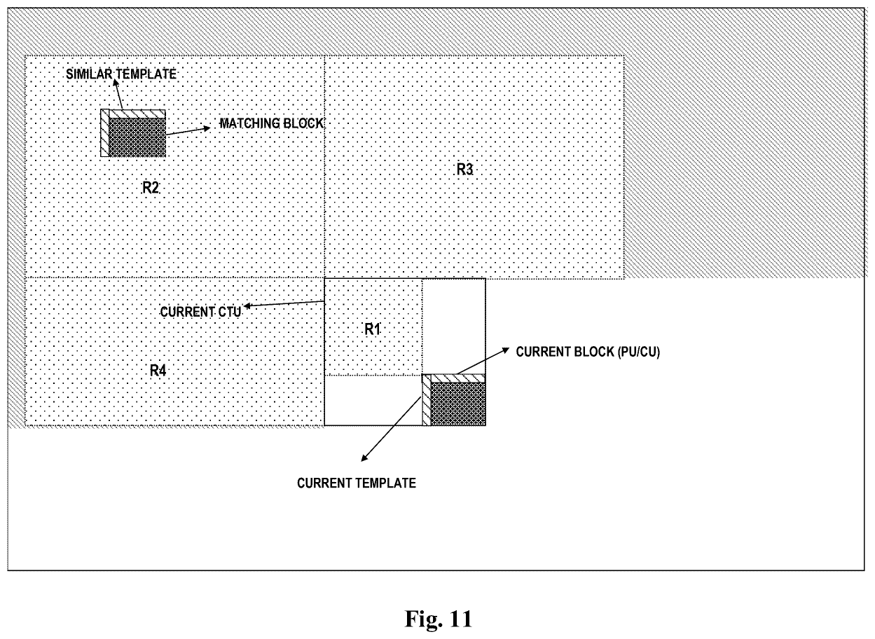

FIG. 11 illustrates an intra template matching search area used. The prediction signal is generated by matching the L-shaped causal neighbor of the current block with another block in a predefined search area in FIG. 11 consisting of:
R1: current CTU,
R2: top-left CTU,
R3: above CTU,
R4: left CTU.

Sum of absolute differences (SAD) is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$\begin{matrix}SearchRange\_w = a * BlkW , \\ SearchRange\_h = a * BlkH .\end{matrix}$$

Where ‘a’ is a constant that controls the gain/complexity trade-off. In practice, ‘a’ is equal to 5.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

2.8. Using Block Vector Derived from IntraTMP for IBC

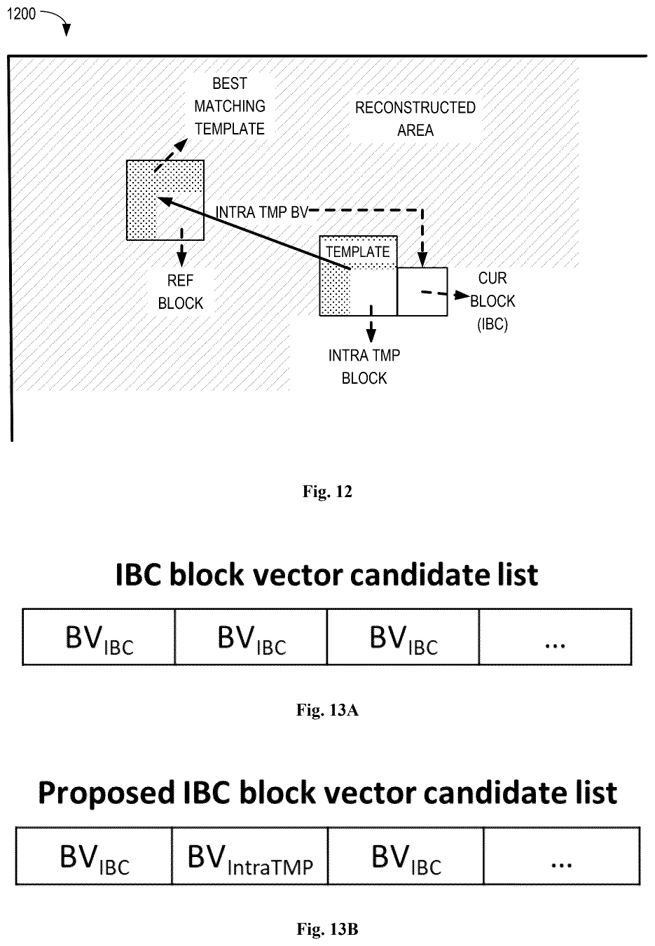

Using block vector derived from IntraTMP for IBC was proposed. The proposed method is to store IntraTMP block vector in the IBC block vector buffer and, the current IBC block can use both IBC BV and IntraTMP BV of neighbouring blocks as BV candidate for IBC BV candidate list as shown in FIG. 12, which illustrates use of IntraTMP block vector for IBC block.

FIG. 13A and FIG. 13B show examples of comparing the block vector candidates which are from only IBC coded neighbouring blocks in the IBC block vector candidate list and the block vector candidates which are from both IBC and IntraTMP coded neighbouring blocks in the proposed IBC block vector candidate list. The IntraTMP block vectors are added to IBC block vector candidate list as spatial candidates.

FIG. 13A illustrates an example of IBC block vector candidate list existing only IBC block vectors. FIG. 13B illustrates an example of IBC block vector candidate list existing both IBC and IntraTMP block vectors.

It is noted that the proposed method makes IBC block vector prediction more efficient by using diverse block vectors without additional memory for storing block vectors.

2.9. Adaptive Reordering of Merge Candidates with Template Matching (ARMC-TM)

The merge candidates are adaptively reordered with template matching (TM). The reordering method is applied to regular merge mode, TM merge mode, and affine merge mode (excluding the SbTMVP candidate). For the TM merge mode, merge candidates are reordered before the refinement process.

An initial merge candiate list is firstly constructed according to given checking order, such as spatial, TMVPs, non-adjcent, HMVPs, pairwise, virtual merge candidates. Then the candidates in the initial list are divided into several subgroups. For the template matching (TM) merge mode, adaptive DMVR mode, each merge candidate in the initial list is firstly refined by using TM/multi-pass DMVR. Merge candidates in each subgroup are reordered to generate a reordered merge candiate list and the reordering is according to cost values based on template matching. The index of selected merge candidate in the reordered merge candidate list is signalled to the decoder. For simplification, merge candidates in the last but not the first subgroup are not reordered. All the zero candidates from the ARMC reordering process are excluded during the construction of Merge motion vector candidates list. The subgroup size is set to 5 for regular merge mode and TM merge mode. The subgroup size is set to 3 for affine merge mode.

### Cost Calculation

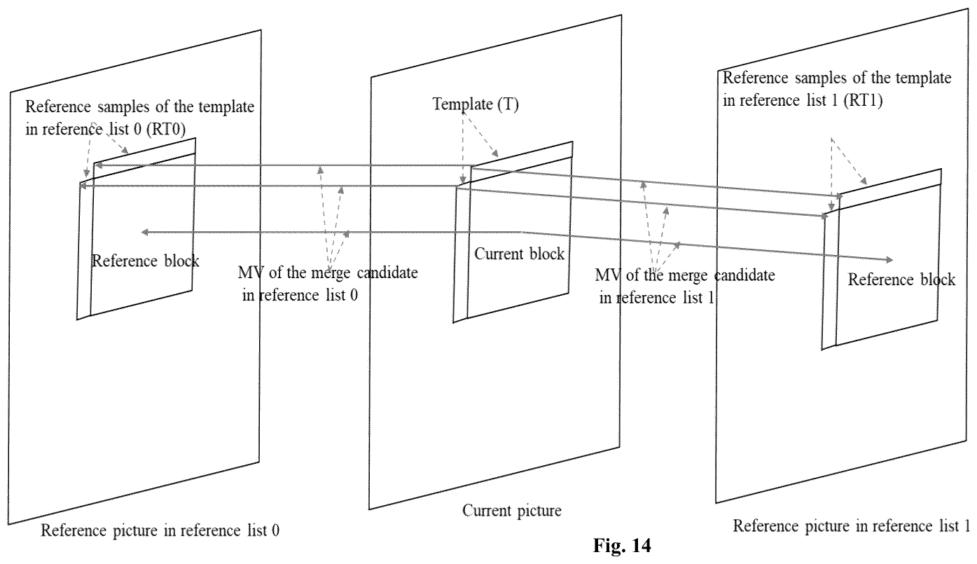

The template matching cost of a merge candidate during the reordering process is measured by the SAD between samples of a template of the current block and their corresponding reference samples. The template comprises a set of reconstructed samples neighboring to the current block. Reference samples of the template are located by the motion information of the merge candidate. When a merge candidate utilizes bi-directional prediction, the reference samples of the template of the merge candidate are also generated by bi-prediction as shown in FIG. 14, which illustrates template and reference samples of the template in reference pictures.

### Refinement of the Initial Merge Candidate List

When multi-pass DMVR is used to derive the refined motion to the initial merge candidate list only the first pass (i.e., PU level) of multi-pass DMVR is applied in reordering. When template matching is used to derive the refined motion, the template size is set equal to 1. Only the above or left template is used during the motion refinement of TM when the block is flat with block width greater than 2 times of height or narrow with height greater than 2 times of width. TM is extended to perform 1/16-pel MVD precision. The first four merge candidates are reordered with the refined motion in TM merge mode.

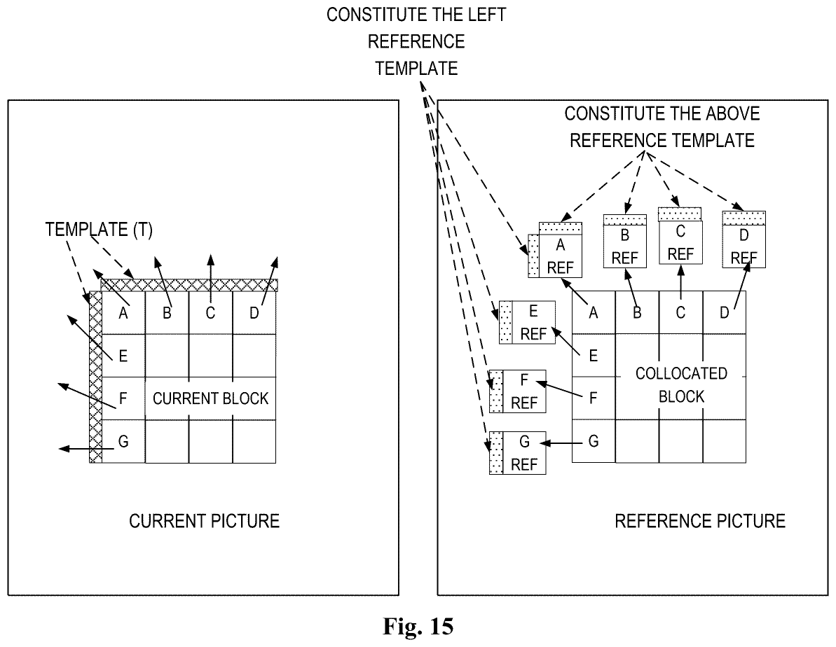

For subblock-based merge candidates with subblock size equal to Wsub×Hsub, the above template comprises several sub-templates with the size of Wsub×1, and the left template comprises several sub-templates with the size of 1×Hsub. As shown in FIG. 15, which illustrates template and reference samples of the template for block with sub-block motion using the motion information of the subblocks of the current block, the motion information of the subblocks in the first row and the first column of current block is used to derive the reference samples of each sub-template.

### Reordering Criterial

In the reordering process, a candidate is considered as redundant if the cost difference between a candidate and its predecessor is inferior to a lambda value e.g. |D1−D2|<λ, where D1 and D2 are the costs obtained during the first ARMC ordering and λ is the Lagrangian parameter used in the RD criterion at encoder side.

The proposed algorithm is defined as the following:
Determine the minimum cost difference between a candidate and its predecessor among all candidates in the list.
   If the minimum cost difference is superior or equal to λ, the list is considered diverse enough and the reordering stops.
   If this minimum cost difference is inferior to λ, the candidate is considered as redundant and it is moved at a further position in the list. This further position is the first position where the candidate is diverse enough compared to its predecessor.
The algorithm stops after a finite number of iterations (if the minimum cost difference is not inferior to A).

This algorithm is applied to the Regular, TM, BM and Affine merge modes. A similar algorithm is applied to the Merge MMVD and sign MVD prediction methods which also use ARMC for the reordering.

The value of λ is set equal to the λ of the rate distortion criterion used to select the best merge candidate at the encoder side for low delay configuration and to the value λ corresponding to a another QP for Random Access configuration. A set of λ values corresponding to each signaled QP offset is provided in the SPS or in the Slice Header for the QP offsets which are not present in the SPS.

### Extension to AMVP Modes

The ARMC design is also applicable to the AMVP mode wherein the AMVP candidates are reordered according to the TM cost. For the template matching for advanced motion vector prediction (TM-AMVP) mode, an initial AMVP candidate list is constructed, followed by a refinement from TM to construct a refined AMVP candidate list. In addition, an MVP candidate with a TM cost larger than a threshold, which is equal to five times of the cost of the first MVP candidate, is skipped.

Note, when wrap around motion compensation is enabled, the MV candidate shall be clipped with wrap around offset taken into consideration.

### 2.10. IBC MBVD List Derivation

It proposes to allow adaptive BVD offsets along MBVD directions. A MBVD list of K candidates with lowest template SAD costs are derived as following steps:
1. Denote the largest offset as N-pel, e.g. N=128, the number of directions D, e.g. D=4 (left, right, top, and bottom), the starting search interval M-pel, e.g. M=8, the number of candidates in MBVD list is K, e.g. K=8.
2. Along each direction, check the TM SAD cost for an offset of every M-th position not exceeding N. The K lowest TM SAD cost candidates are kept in the list.
3. For each candidate in the list, check the TM SAD cost of the two candidates with the offset equal to +−M/2 along the direction. The K lowest TM SAD cost candidates are kept in the list.
4. Repeat step 3, while reducing the interval M by half until it reaches 1-pel.

The amount of MBVD candidates and MBVD index signaling is kept the same as ECM-7.0.

2.11. IntraTMP with Half-Pel Precision

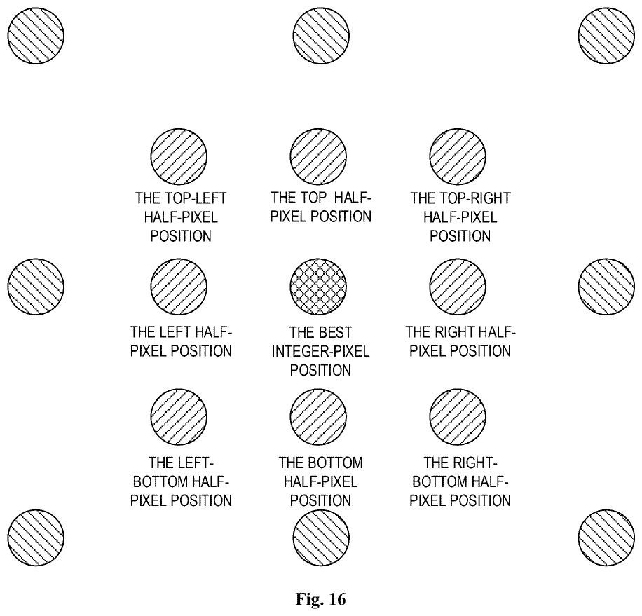

It is proposed to enable half-pel precision in Intra TMP. The template matching process is not changed, which will find an integer-pel matching position. In the proposed method, the encoder will further try 8 adjacent half-pel positions around the integer-pel position in 8 directions as shown in the FIG. 16 and select one of the 9 positions (1 integer-pel position+8 half-pel positions) by RDO. FIG. 16 shows the adjacent half-pel positions in 8 directions.

If Intra TMP mode is selected for the current block, a flag is further signaled to indicate whether to use integer-pel or half-pel precision. When using half-pel precision, an index is further signaled to indicate the direction of the half-pel position. A 4-tap DCT-IF interpolation filter, [−5, 37, 37, −5], is used for half-pel interpolation in Intra TMP.

### 2.12. IBC Adaptation for Coding Of Natural Content

In aspect 1, the modification of IBC are as follows:
In ECM-7.0, some partitioning depth is skipped depending on the POC distance of the current picture and nearest reference picture. When IBC is enabled from SPS level, this POC distance is set to 0. In this proposal, for inter-slices, the true POC distance is used instead of setting to 0.
At the encoder, IBC BV search range is restricted to 32 pixels.
IBC is not applied to non-intra slices for natural content. This is indicated by high-level syntax to remove CU level signaling of IBC flag. However, for screen content, IBC is applied to all slices.
SPS level flag for RR-IBC and TM-IBC is introduced.

In aspect 2, Fractional-pel motion compensation is introduced to IBC to support quarter- and half-pel resolutions in addition to existing ones. The signaling of AMVR follows the signaling as of Inter Prediction. The same interpolation filters as for inter prediction is applied.

2.13. IBC with Fractional Block Vectors

For IBC AMVP, by following the existing design of adaptive block vector resolution (ABVR), additional ABVR signaling is introduced for the proposed ½-pel and ¼-pel BV precisions. When any fractional BV precision is enabled, the corresponding BVPs and BVDs are in the unit of the selected precision. At encoder side, the existing integer BV searching methods are performed first and a group of N integer BVs are then selected for further fractional refinement, where ½-pel and ¼-pel BV searching are sequentially applied. The BV with minimum RD cost, either at an integer precision or fractional precision, is signaled to decoder side. In the current design, 8-tap DCT-IF interpolation filters are applied to generate the IBC prediction samples at fractional sample positions. Moreover, in case the interpolation process accesses reconstructed samples beyond the available reference area, padding operations are conducted, which are copied from the nearest integer sample position within the valid reference area.

For IBC merge mode, fractional BVs are inherited through spatial neighbors, as same as the existing IBC inheritance process in the ECM-7.0.

### 2.14. IBC-CIIP, IBC-GPM, and IBC-LIC

### 2.14.1. The First Scheme of IBC-CIIP

Combined intra block copy and intra prediction (IBC-CIIP) is a coding tool for a CU which uses IBC with merge mode and intra prediction to obtain two prediction signals, and the two prediction signals are weighted summed to generate the final prediction. Specifically, if the intra prediction is planar or DC mode, the final prediction is obtained as follows:

$$P = ( {w}_{ibc} * {P}_{ibc} + ( ( 1 ≪ shift ) - {w}_{ibc} ) * {P}_{intra} + ( 1 ≪ ( shift - 1 ) ) ) ≫ shift$$

wherein P_{ibc} and Pᵢₙₜᵣₐ denote the IBC prediction signal and intra prediction signal, respectively. (w_{ibc}, shift) are set equal to (1, 2) if both the up and left CUs are intra coded, (2, 2) if one of the up and left CUs are intra coded, (3, 2) if both the up and left CUs are IBC coded. Otherwise (i.e., if the intra prediction is directional mode), the final prediction is obtained by adaptively switching the prediction samples of the intra mode and the IBC. For purpose of illustration, assuming the size of the current CU is w*h and the intra mode is horizontal or vertical, the left 3/4w*h part (horizontal mode) or top w*3/4h part (vertical mode) of the final prediction is set to intra prediction signal if both the top and left neighboring CUs are intra coded; and the left ½w*h part (horizontal mode) or the top w*½h part (vertical mode) of the final prediction is set to intra prediction signal if only one of the top and left CUs are intra coded; and the left ¼w*h part (horizontal mode) or the top w*¼h part (vertical mode) of the final prediction is set to intra prediction signal if both the up and left CUs are IBC or inter coded. In the above, besides the intra prediction portion, the other part of the final prediction is set to the IBC prediction samples.

### 2.14.2 The Second Scheme of IBC-CIIP

Combined intra block copy and intra prediction (IBC-CIIP) is a coding tool for a CU which uses IBC and intra prediction to obtain two prediction signals, and the two prediction signals are weighted summed to generate the final prediction as follows:

$$P = ( {w}_{ibc} * {P}_{ibc} + ( ( 1 ≪ shift ) - {w}_{ibc} ) * {P}_{intra} + ( 1 ≪ ( shift - 1 ) ) ) ≫ shift$$

wherein P_{ibc} and Pᵢₙₜᵣₐ denote the IBC prediction signal and intra prediction signal. (w_{ibc}, shift) are set equal to (13, 4) and (1, 1) for IBC merge mode and IBC AMVP mode.

An intra prediction mode (IPM) candidate list is used to generate the intra prediction signal, and the IPM candidate list size is pre-defined as 2. An IPM index is signalled to indicate which IPM is used.

2.14.3 IBC with Geometry Partitioning (IBC-GPM)

Intra block copy with geometry partitioning mode (IBC-GPM) is a coding tool which divides a CU into two sub-partitions geometrically. The prediction signals of the two sub-partitions are generated using IBC and intra prediction. IBC-GPM can be applied to regular IBC merge mode or IBC-TM merge mode. An intra prediction mode (IPM) candidate list is constructed using the same method as GPM with inter and intra prediction for intra prediction, and the IPM candidate list size is pre-defined as 3. There are 48 geometry partitioning modes in total, which are divided into two geometry partitioning mode sets as follows:

TABLE 1
Geometry partitioning modes in the first
geometry partitioning mode set

| ibc_gpm_partition_idx | 0 | 1 | 2 | 3 | 4 | 5 | 6 | 7 |
|---|---|---|---|---|---|---|---|---|
| angleIdx | 0 | 0 | 8 | 8 | 16 | 16 | 24 | 24 |
| distanceIdx | 1 | 3 | 1 | 3 | 1 | 3 | 1 | 3 |

TABLE 2
Geometry partitioning modes in the second
geometry partitioning mode set

| ibc_gpm_partition_idx | 0 | 1 | 2 | 3 | 4 | 5 | 6 | 7 | 8 | 9 |
|---|---|---|---|---|---|---|---|---|---|---|
| angleIdx | 2 | 2 | 2 | 3 | 3 | 3 | 4 | 4 | 4 | 5 |
| distanceIdx | 0 | 1 | 3 | 0 | 1 | 3 | 0 | 1 | 3 | 0 |
| ibc_gpm_partition_idx | 10 | 11 | 12 | 13 | 14 | 15 | 16 | 17 | 18 | 19 |
| angleIdx | 5 | 5 | 11 | 11 | 11 | 12 | 12 | 12 | 13 | 13 |
| distanceIdx | 1 | 3 | 0 | 1 | 3 | 0 | 1 | 3 | 0 | 1 |
| ibc_gpm_partition_idx | 20 | 21 | 22 | 23 | 24 | 25 | 26 | 27 | 28 | 29 |
| angleIdx | 13 | 14 | 14 | 14 | 18 | 18 | 19 | 19 | 20 | 20 |
| distanceIdx | 3 | 0 | 1 | 3 | 1 | 3 | 1 | 3 | 1 | 3 |
| ibc_gpm_partition_idx | 30 | 31 | 32 | 33 | 34 | 35 | 36 | 37 | 38 | 39 |
| angleIdx | 21 | 21 | 27 | 27 | 28 | 28 | 29 | 29 | 30 | 30 |
| distanceIdx | 1 | 3 | 1 | 3 | 1 | 3 | 1 | 3 | 1 | 3 |

When IBC-GPM is used, an IBC-GPM geometry partitioning mode set flag is signalled to indicate whether the first or the second geometry partitioning mode set is selected, followed by the geometry partitioning mode index. An IBC-GPM intra flag is signalled to indicate whether intra prediction is used for the first sub-partition. When intra prediction is used for a sub-partition, an intra prediction mode index is signalled. When IBC is used for a sub-partition, a merge index is signalled.

2.14.4 IBC with Local Illumination Compensation (IBC-LIC)

Intra block copy with local illumination compensation (IBC-LIC) is a coding tool which compensates the local illumination variation within a picture between the CU coded with IBC and its prediction block with a linear equation. The parameters of the linear equation are derived same as LIC for inter prediction except that the reference template is generated using block vector in IBC-LIC. IBC-LIC can be applied to IBC AMVP mode and IBC merge mode. For IBC AMVP mode, an IBC-LIC flag is signalled to indicate the use of IBC-LIC. For IBC merge mode, the IBC-LIC flag is inferred from the merge candidate.

### 2.15. Block Vector Difference Sign Prediction for IBC Blocks

Block vector difference sign prediction (BVDSP) can be applied for IBC blocks when the block vector difference contains non-zero component. Possible BVD sign combinations are sorted according to template matching cost and index corresponding to the true BVD sign is derived and coded with context model. At decoder side, the BVD signs are derived as following major steps:
Step1: 4 candidate BVs are derived by BVP and combinations between possible signs and absolute BVD

$$\begin{matrix}( BVP [ 0 ] + abs BVD [ 0 ] , BVP [ 1 ] + abs BVD [ 1 ] ) \\ ( BVP [ 0 ] + abs BVD [ 0 ] , BVP [ 1 ] - abs BVD [ 1 ] ) \\ ( BVP [ 0 ] - abs BVD [ 0 ] , BVP [ 1 ] + abs BVD [ 1 ] ) \\ ( BVP [ 0 ] - abs BVD [ 0 ] , BVP [ 1 ] - abs BVD [ 1 ] )\end{matrix}$$

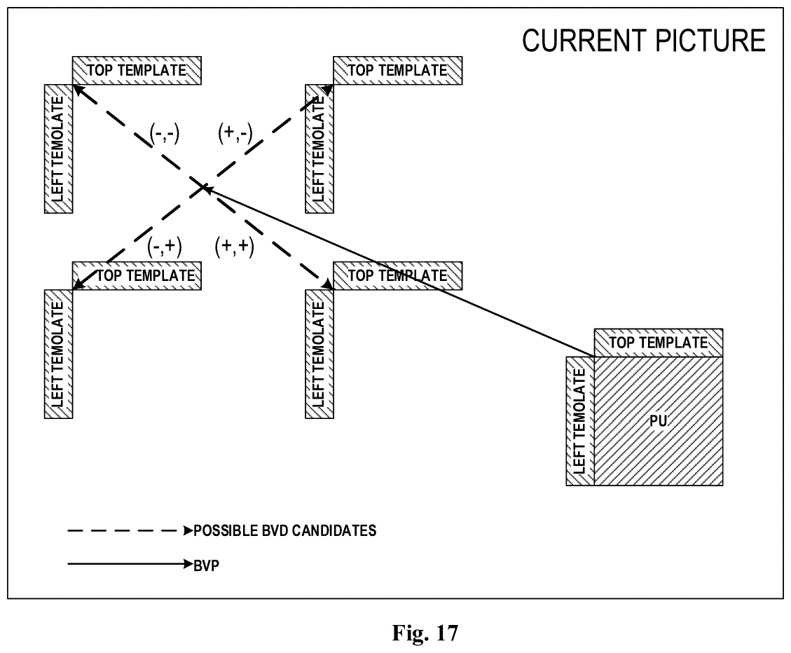

Step2: Derive prediction costs of 4 candidate BVs based on template matching and sort them according to the costs
Step3: Use BVDSP index to pick the true BVD sign
Step4: Add the true BVD to the BVP to get the final BV
The template matching cost is measured by the SAD between the neighbouring samples of the current CU and their corresponding reference samples, as illustrated in FIG. 17. FIG. 17 shows template matching cost derivation in BVDSP.
The Step3 of deriving the true BVD signs from BVDSP index is same as [2]. This test codes the index with a single ctxTable different from [2] in the initialization process. In [2], two ctxTables are employed which select the ctxIdx based on the magnitude of the BVD.

In general case 4 BVD candidates are evaluated (+/−bvd_abs.x, +/−bvd_abs.y). If one of BVD components (x or y) is zero, only 2 BVD candidates are possible. Case when all BVD component are zero is trivial and no sign derivation is needed.

### 2.16. Block Vector Difference Prediction for IBC Blocks

It is proposed to apply sign prediction to BVD and further extend this approach for predicting suffix bins of BVD magnitudes. Suffix bins are also derived at the decoder side by comparing values of signalled bins with the bins of the best candidates obtained with template matching. The maximum number of bins to be predicted for a PU is controlled by a macro. By setting this macro, we investigate 4 configurations that corresponds the 4 sub-tests where the following number of BVD bins are predicted:
Test a: up to 2 BVD signs and 4 BVD suffix bins;
Test b: up to 2 BVD signs and 6 BVD suffix bins;
Test c: up to 2 BVD signs and 8 BVD suffix bins;
Test d: up to 2 BVD signs and 10 BVD suffix bins.

The most significant bins of magnitude suffixes of BVD horizontal and vertical components are predicted, and the prediction match result is coded in the bitstream using CABAC context mode. The less significant bins of magnitude suffixes of horizontal and vertical BVD components are coded in by-pass mode.

### 2.17. Multi-Candidate IntraTMP

IntraTMP selects only one BV which has the smallest template matching cost. In camera captured content, the decoder can hardly find a perfect match. There are usually several blocks that are similar to current block and their template matching cost are comparable. The BV with the smallest template matching cost may not be the best predictor.

This contribution proposes to use multiple candidates for IntraTMP. A candidate list is constructed and the candidate BVs are ranked in ascending order of their template matching costs. An index is signaled in the bit-stream to indicate which candidate BV is actually used for current block. This method uses template matching to select a shortlist of promising candidates from a huge amount of possible BVs and allows the encoder, who can refer to the original current block, to make the final decision.

The syntax change is as follow:

```
  ...
  intra_tmp_flag
  if(intra_tmp_flag) {
intra_tmp_idx
  }
  ...
```

Where intra_tmp_flag equals to 1 means that current block uses IntraTMP and intra_tmp_idx further indicates which BV in the candidate BV list will be used to identify the prediction block.

To build the candidate list, a sparse search and a refinement search are used. In the sparse search, the sub-sampling factor is 3 instead of 2 in ECM7.0 and the top 30 BVs are maintained. In the refinement search, each 3x3 block around each of the 30 BVs is checked and the top 15 BVs are selected to form the candidate list.

### 3. Problems

In current IBC-MBVD prediction, only two horizontal and two vertical offset directions and integer-pel BVD offsets are utilized. To further improve the efficiency of IBC-MBVD prediction, more offset directions and/or fractional-pel BVD offsets are used.

When performing template matching process (e.g., refinement/reordering/searching/LIC) for IBC and IntraTMP, only integer-pel block vector is used to derive the reference template

### 4. Detailed Solutions

The detailed embodiments below should be considered as examples to explain general concepts. These embodiments should not be interpreted in a narrow way. Furthermore, these embodiments can be combined in any manner.

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

W and H are the width and height of current block (e.g., luma block).

For an IBC and Intra TMP coded block, a block vector (BV) is used to indicate the displacement from the current block to a reference block, which is already or partially reconstructed inside the current picture.

In the following, the block can be any block which has BV, which is not limited to an IBC or IntraTMP coded block.

In the following, a BV candidate is a BV predictor or a searching point. One block has BV information if it is IBC coded or IntraTMP coded.

In one example, the BVDs may be derived by combining the BVD offsets and the offset directions.

In one example, the BVD may be set to (xDir[dirIdx]*offsetBVD, yDir[dirIdx]*offsetBVD), wherein, xDir[]={1, −1, 0, 0, 1, −1, 1, −1, 2, −2, −2, 2, 1, −1, −1, 1} and yDir[]={0, 0, 1, −1, 1, −1, −1, 1, 1, −1, 1, −1, 2, −2, 2, −2}, dirIdx is the offset direction index, offsetBVD is the BVD offset. When (xDir[dirIdx], yDir[dirIdx]) is (1, 0) or (−1,0), the offset direction is horizontal; when (xDir[dirIdx], yDir[dirIdx]) is (0, 1) or (0, −1), the offset direction is vertical; when (xDir[dirIdx], yDir[dirIdx]) is (1, 1), or (−1, −1), or (1, −1),or (−1, 1), the offset direction is along the k×π/4 diagonal angles: when (xDir[dirIdx], yDir[dirIdx]) is (2, 1), or (−2, −1), or (−2, 1), or (2, −1), or (1, 2), or (−1, −2), or (−1, 2), or (1, −2), the offset direction is approximately along the k×π/8 diagonal angles.

### IBC-MBVD Prediction

1. In one example, in IBC-MBVD prediction, the BVD offsets may be different for horizontal directions and vertical directions.
a. In one example, the BVD offsets for vertical directions may be a subset of the BVD offsets for horizontal directions.
   (a) Alternatively, the BVD offsets for horizontal directions may be a subset of the BVD offsets for vertical directions.
b. In one example, the largest BVD offset for vertical directions may be smaller than the largest BVD offset for horizontal directions.
   (a) Alternatively, the largest BVD offset for vertical directions may be larger than or equal to the largest BVD offset for horizontal directions.
c. In one example, the BVD offsets along different directions may be different.
d. Alternatively, in IBC-MBVD prediction, the BVD offsets may be the same for horizontal directions and vertical directions.

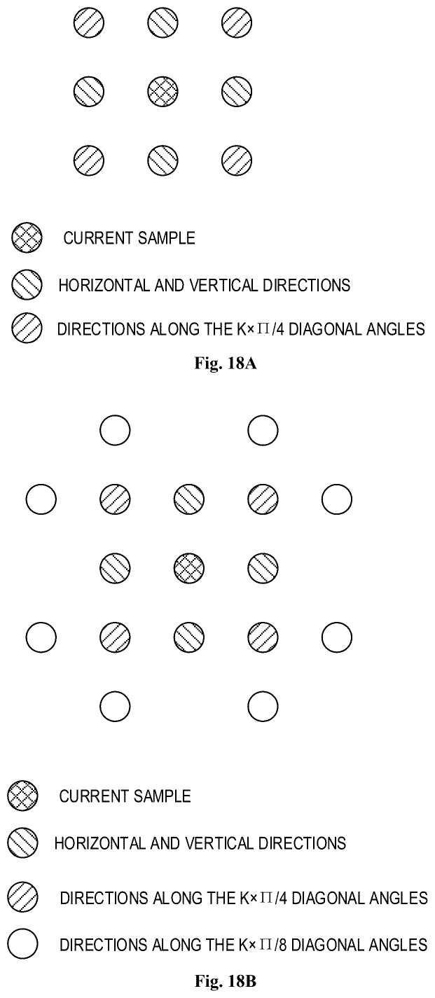

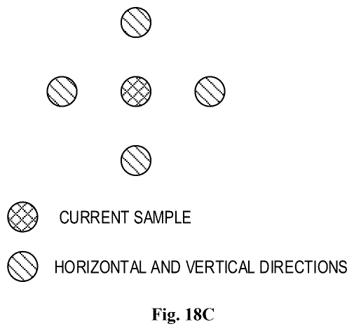

2. In one example, the IBC-MBVD design may be different for natural content and screen content.
a. In one example, the BVD offsets may be different for natural content and screen content.
   (a) In one example, the fractional-pel BVD offsets may be introduced for both natural content and screen content.
   (b) In one example, the fractional-pel BVD offsets may be only introduced for natural content.
      1) In one example, the BVD offset set may be {¼-pel, ½-pel, 1-pel, 2-pel, 4-pel, 8-pel}
      2) In one example, the BVD offset set may be {½-pel, 1-pel, 2-pel, 4-pel, 8-pel, 16-pel}
      3) In one example, the BVD offset set may be {¼-pel, ½-pel, 1-pel, 2-pel, 4-pel, 8-pel, 16-pel, 32-pel}
      4) In one example, the BVD offset set may be {¼-pel, ½-pel, 1-pel, 2-pel, 3-pel, 4-pel, 6-pel, 8-pel, 10-pel, 12-pel, 14-pel, 16-pel, 18-pel, 20-pel, 22-pel, 24-pel, 26-pel, 28-pel, 30-pel, 32-pel}.
   (c) In one example, the BVD offsets of natural content may be the BVD offsets of screen content multiplied by a factor.
      1) In one example, the factor may be less than 1.
         i. In one example, the factor may be ¼. (i) In one example, if the BVD offsets of screen content are {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, the BVD offsets of natural content may be {¼-pel, ½-pel, 1-pel, 2-pel, 3-pel, 4-pel, 6-pel, 8-pel, 10-pel, 12-pel, 14-pel, 16-pel, 18-pel, 20-pel, 22-pel, 24-pel, 26-pel, 28-pel, 30-pel, 32-pel}.
         ii. In one example, the factor may be ½.
   (d) In one example, when allowing adaptive BVD offsets along MBVD directions (an example shown in section 2.10), the interval M may be reduced by half until it reaches a fractional-pel.
      1) In one example, the fractional-pel may be ¼-pel.
      2) In one example, the fractional-pel may be ½-pel.
   (e) In one example, when allowing adaptive BVD offsets along MBVD directions (an example shown in section 2.10), for the selected N (e.g., first N) candidates in the list, check the template matching cost of the two candidates with the offset equal to +−M/2 along the selected candidate direction. The candidate(s) with K lowest template matching cost(s) are kept in the list.
      1) In one example, N may be smaller than or equal to K.
         i. In one example, N may be 1,2,3, . . . , K−2, K−1, K.
      2) In one example, N may be different for different M settings.
         i. In one example, if M=1, N may be 4.
         ii. In one example, if M=½, N may be 2 or 4.
         iii. In one example, if M≥1 or M>1, N may be 8.
      3) Alternatively, N may be the same for different M settings.
   (f) Alternatively, the BVD offsets may be the same for natural content and screen content.
b. In one example, the offset directions may be different for natural content and screen content.
   (a) In one example, the offset directions for natural content may include directions along the horizontal, the vertical, and the k×π/4 diagonal angles as shown in FIG. 18A.
   (b) In one example, the offset directions for natural content may include directions along the horizontal, the vertical, the k×π/4 diagonal angles, and the k×π/8 diagonal angles as shown in FIG. 18B.
   (c) Alternatively, the offset directions may be the same for natural content and screen content.
      1) In one example, the offset directions for both natural content and screen content may include horizontal directions and vertical directions as shown in FIG. 18C.
c. In one example, the base candidates may be different for natural content and screen content.
   (a) In one example, the number of base candidates for natural content may be smaller than the number of base candidates for screen content.
      1) In one example, the number of base candidates for natural content may be 3, the number of base candidates for screen content may be 5.
   (b) In one example, the number of base candidates for natural content may be larger than the number of base candidates for screen content.
   (c) Alternatively, the number of base candidates for natural content may be equal to the number of base candidates for screen content.
      1) In one example, the number of base candidates for natural content and the number of base candidates for screen content may be 5.

3. In one example, the natural content and screen content may be indicated at sequence level/group of pictures level/picture level/slice level/tile group level, such as in sequence header/picture header/SPS/VPS/DPS/DCI/PPS/APS/slice header/tile group header.
a. In one example, the sequence header/picture header/SPS/VPS/DPS/DCI/PPS/APS/slice header/tile group header flag may be set based on the hash block hit percentage at encoder and signalled to the decoder. If the hash block hit percentage of the video sequence/picture/slice/tile is larger than a threshold, the video sequence/picture/slice/tile may be interpreted as screen content; otherwise, the video sequence/picture/slice/tile may be interpreted as natural content.
   (a) In one example, if the hash block hit percentage of the first frame for entire sequence is larger than a threshold, the video sequence may be interpreted as screen content; otherwise, the video sequence may be interpreted as natural content.
b. In one example, the sequence header/picture header/SPS/VPS/DPS/DCI/PPS/APS/slice header/tile group header flag may be predefined.

4. In one example, the natural content and screen content may be indicated at PB/TB/CB/PU/TU/CU/VPDU/CTU/CTU row/slice/tile/sub-picture/other kinds of region contain more than one sample or pixel.
a. In one example, the indication flag may be signalled.
b. In one example, the indication flag may be derived.
   (a) In one example, the indication flag may be derived according to the coding mode of some neighboring blocks of current block.
      1) In one example, the coding mode may be IBC or IntraTMP or other coding mode which has BV.

5. Whether to apply fractional IBC-MBVD may be indicated in the bitstream
a. In one example, whether to apply fractional IBC-MBVD may be signalled by a flag at tile/slice/sub-picture/picture/sequence level.
b. In one example, whether to apply fractional IBC-MBVD may be signalled by a flag at PB/TB/CB/PU/TU/CU/VPDU/CTU/CTU row level.
c. In one example, whether to apply fractional IBC-MBVD may be derived from syntax elements in the bitstream.

### Template Matching Process

6. In one example, the reordering/refinement/searching/LIC process may be performed for a block which has BV.
a. In one example, the reordering/refinement/searching/LIC process may be based on template matching.
b. In one example, the block may be IBC coded or IntraTMP coded.
c. In one example, when performing template matching process (e.g., refinement/reordering/searching/LIC) for a block which has BV, if the corresponding block vector is in fractional-pel precision, N-tap interpolation filter may be used to get the reference samples of current template.
   (a) In one example, N is 2, 4, 6, 8, 10, or 12.
   (b) In one example, bilinear interpolation filter may be used to get the reference samples of current template.
d. In one example, when performing template matching process (e.g., refinement/reordering/searching/LIC) for a block which has BV, if the corresponding block vector is in fractional-pel precision, the fractional-pel BV may be rounded to the integer-pel accuracy, where the integer-pel BV may be its nearest integer BV, no interpolation filter may be used to get the reference samples of current template.
   (a) Alternatively, rounding up or rounding down may be used to get the integer-pel BV from fractional-pel BV.
   (b) In one example, different directions may use different rounding, e.g., rounding to the nearest, rounding up or rounding down.
e. In one example, the process may be template matching reordering for at least one of regular IBC merge/AMVP candidate list, or IBC-TM merge/AMVP candidate list, IBC-MBVD base candidate list, IBC-MBVD candidate list, IBC merge/AMVP candidate list used in IBC-CIIP, regular IBC merge candidate list or IBC-TM merge candidate list used in IBC-GPM, BVD sign prediction for IBC AMVP and/or IBC-MBVD modes, BVD magnitude suffix bins prediction for IBC AMVP and/or IBC-MBVD modes, multi-candidate list construction of IntraTMP or any other template matching reordering for a block which has BV.
f. In one example, the process may be template matching refinement for IBC-TM merge/AMVP or any other template matching refinement for a block which has BV.
g. In one example, the process may be template matching searching for IntraTMP or any other template matching searching for a block which has BV.
h. In one example, the process may be IBC-LIC.

### General Information

7. A syntax element disclosed above may be binarized as a flag, a fixed length code, an EG(x) code, a unary code, a truncated unary code, a truncated binary code, etc. It can be signed or unsigned.

8. A syntax element disclosed above may be coded with at least one context model. Or it may be bypass coded.

9. A syntax element (SE) disclosed above may be signaled in a conditional way.
a. The SE is signaled only if the corresponding function is applicable.

10. A syntax element disclosed above may be signaled at block level/sequence level/group of pictures level/picture level/slice in coding level/tile group level, such as structures of CTU/CU/TU/PU/CTB/CB/TB/PB, or sequence header/picture header/SPS/VPS/DPS/DCI/PPS/APS/slice header/tile group header.

11. In above examples, the block may refer to the colour component/sub-picture/slice/tile/coding tree unit (CTU)/CTU row/groups of CTU/coding unit (CU)/prediction unit (PU)/transform unit (TU)/coding tree block (CTB)/coding block (CB)/prediction block (PB)/transform block (TB)/a block/sub-block of a block/sub-region within a block/any other region that contains more than one sample or pixel.

12. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.

13. Whether to and/or how to apply the disclosed methods above may be signalled at PB/TB/CB/PU/TU/CU/VPDU/CTU/CTU row/slice/tile/sub-picture/other kinds of region contain more than one sample or pixel.

14. Whether to and/or how to apply the disclosed methods above may be dependent on coded information, such as block size, colour format, single/dual tree partitioning, colour component, slice/picture type.

FIG. 18A to FIG. 18C show offset directions, respectively.

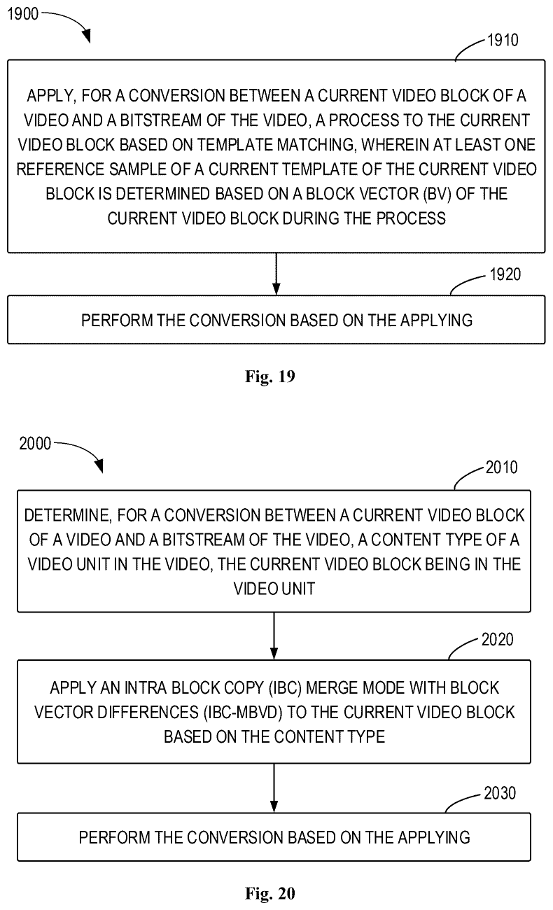

More details will be further discussed below. FIG. 19 illustrates a flowchart of a method 1900 for video processing in accordance with embodiments of the present disclosure. The method 1900 is implemented for a conversion between a current video block of a video and a bitstream of the video.

At block 1910, a process is applied to the current video block based on template matching. At least one reference sample of a current template of the current video block is determined based on a block vector (BV) of the current video block during the process.

At block 1920, the conversion is performed based on the applying. In some embodiments, the conversion includes encoding the current video block into the bitstream. Alternatively, or in addition, in some embodiments, the conversion includes decoding the current video block from the bitstream.

The method 1900 enables performing a template matching based process for a block which has BV. In this way, the coding efficiency and coding effectiveness can be improved.

In some embodiments, the process comprises at least one of: a reordering process, a refinement process, a searching process, or a local illumination compensation (LIC) process. For example, the reordering/refinement/searching/LIC process may be based on template matching.

In some embodiments, the BV of the current video block is in a fractional-pel precision, and the at least one reference sample is determined by an interpolation filter with N-tap, N being an integer larger than one. That is, if the corresponding BV is in fractional-pel precision, N-tap interpolation filter may be used to get the reference samples of current template.

In some embodiments, N comprises one of: 2, 4, 6, 8, 10 or 12.

In some embodiments, the interpolation filter comprises a bilinear interpolation filter.

In some embodiments, the process comprises a template matching reordering process for at least one of: a regular intra block copy (IBC) merge candidate list, an IBC advanced motion vector prediction (AMVP) candidate list, an IBC template matching (IBC-TM) merge candidate list, an IBC-TM AMVP candidate list, an IBC merge mode with block vector differences (IBC-MBVD) base candidate list, an IBC-MBVD candidate list, an IBC merge candidate list used in IBC combined intra and inter prediction mode (CIIP), a regular IBC merge candidate list or IBC-TM merge candidate list used in IBC geometric partitioning mode (GPM), a block vector difference (BVD) sign prediction for IBC AMVP mode, a BVD sign prediction for IBC-MBVD mode, a BVD magnitude suffix bins prediction for IBC AMVP mode, a BVD magnitude suffix bins prediction for IBC-MBVD mode, a multi-candidate list construction of intra template matching prediction (IntraTMP), or a further template matching reordering for a block with a BV.

In some embodiments, the process comprises at least one of: a template matching refinement for intra block copy (IBC) template matching (TM) merge, a template matching refinement for IBC-TM advanced motion vector prediction (AMVP), or a further template matching refinement for a block with a BV. That is, the process may be template matching refinement for IBC-TM merge/AMVP or any other template matching refinement for a block which has BV.

In some embodiments, the process comprises at least one of: a template matching searching for intra template matching prediction (IntraTMP), or a further template matching searching for a block with a BV. For example, the process may be template matching searching for IntraTMP or any other template matching searching for a block which has BV.

In some embodiments, the process comprises an intra block copy (IBC) local illumination compensation (LIC) process.

In some embodiments, the block is coded with at least one of: an intra block copy (IBC) mode, or an intra template matching prediction (IntraTMP) mode.

In some embodiments, the BV of the current video block is in a fractional-pel precision. The method may further comprise: updating the BV to an integer-pel precision, the at least one reference sample of the current template being determined based on the updated BV without using an interpolation filter. For example, when performing template matching process (e.g., refinement/reordering/searching/LIC) for a block which has BV, if the corresponding block vector is in fractional-pel precision, the fractional-pel BV may be rounded to the integer-pel accuracy, where the integer-pel BV may be its nearest integer BV, no interpolation filter may be used to get the reference samples of current template.

In some embodiments, the BV is updated by a rounding up or a rounding down to the integer-pel precision.

In some embodiments, a plurality of BVs in a plurality of directions is updated by a plurality of rounding operations, the plurality of rounding operations comprises at least one of: a rounding up, a rounding down, or a rounding to a nearest integer. For example, different directions may use different rounding, e.g., rounding to the nearest, rounding up or rounding down.

According to further embodiments of the present disclosure, a non-transitory computer-readable recording medium is provided. The non-transitory computer-readable recording medium stores a bitstream of a video which is generated by a method performed by an apparatus for video processing. In the method, a process is applied to a current video block of the video based on template matching. At least one reference sample of a current template of the current video block is determined based on a block vector (BV) of the current video block during the process. The bitstream is generated based on the applying.

According to still further embodiments of the present disclosure, a method for storing bitstream of a video is provided. In the method, a process is applied to a current video block of the video based on template matching. At least one reference sample of a current template of the current video block is determined based on a block vector (BV) of the current video block during the process. The bitstream is generated based on the applying. The bitstream is stored in a non-transitory computer-readable recording medium.

FIG. 20 illustrates a flowchart of a method 2000 for video processing in accordance with embodiments of the present disclosure. The method 2000 is implemented for a conversion between a current video block of a video and a bitstream of the video.

At block 2010, a content type of a video unit in the video is determined. The current video block is in the video unit.

At block 2020, an intra block copy (IBC) merge mode with block vector differences (IBC-MBVD) is applied to the current video block based on the content type.

At block 2030, the conversion is performed based on the applying. In some embodiments, the conversion includes encoding the current video block into the bitstream. Alternatively, or in addition, in some embodiments, the conversion includes decoding the current video block from the bitstream.

The method 2000 enables different IBC-MBVD design for different content types, such as for natural content and screen content. In this way, the coding efficiency and/or coding effectiveness can be improved.

In some embodiments, the content type of the video comprises one of: a natural content, or a screen content.

In some embodiments, at least one first block vector difference (BVD) offset for the content type of a natural content is different from at least one second BVD offset for the content type of a screen content.

In some embodiments, the at least one first BVD offset is determined by multiplying the at least one second BVD offset by a factor.

In some embodiments, the factor is less than one.

In some embodiments, the factor comprises ¼.

In some embodiments, the at least one second BVD offset comprises a set of {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the at least one first BVD offset comprises a set of {¼-pel, ½-pel, 1-pel, 2-pel, 3-pel, 4-pel, 6-pel, 8-pel, 10-pel, 12-pel, 14-pel, 16-pel, 18-pel, 20-pel, 22-pel, 24-pel, 26-pel, 28-pel, 30-pel, 32-pel}.

In some embodiments, the factor comprises ½.

In some embodiments, at least one fractional-pel block vector difference (BVD) offset is applied for both a natural content and a screen content.

In some embodiments, at least one fractional-pel block vector difference (BVD) offset is applied for a natural content.

In some embodiments, a set of block vector difference (BVD) offsets for the IBC-MBVD comprises one of: a first set comprising ¼-pel, ½-pel, 1-pel, 2-pel, 4-pel and 8-pel, a second set comprising ½-pel, 1-pel, 2-pel, 4-pel, 8-pel and 16-pel, a third set comprising ¼-pel, ½-pel, 1-pel, 2-pel, 4-pel, 8-pel, 16-pel and 32-pel, or a fourth set comprising ¼-pel, ½-pel, 1-pel, 2-pel, 3-pel, 4-pel, 6-pel, 8-pel, 10-pel, 12-pel, 14-pel, 16-pel, 18-pel, 20-pel, 22-pel, 24-pel, 26-pel, 28-pel, 30-pel and 32-pel.

In some embodiments, a set of adaptive block vector difference (BVD) offsets along at least one MBVD direction is allowed, and an interval between BVD offsets is reduced by half to a fractional-pel.

In some embodiments, the fractional-pel comprises one of: a ¼ pel or a ½ pel.

In some embodiments, applying IBC-MBVD to the current video block comprises: for each selected candidate in a set of selected candidates in an IBC-MBVD candidate list, checking template matching costs of two candidates with an offset between the two candidates and a selected candidate being equal to M/2 and-M/2 along the selected candidate direction, M being an interval value greater than 0; and keeping candidates with lowest K template matching costs in the IBC-MBVD candidate list, K being an integer greater than or equal to 1.

In some embodiments, the set of selected candidates comprises top N candidates in the IBC-MBVD candidate list, N being an integer smaller than or equal to K and greater than or equal to 1.

In some embodiments. N comprises one of: 1, 2, 3, . . . , K−2, K−1, or K.

In some embodiments, a value of N is based on a value of M.

In some embodiments, M is equal to 1, and N is equal to 4.

In some embodiments, M is equal to ½, and N is equal to 2 or 4.

In some embodiments, M is greater than or equal to 1 or M is greater than 1, and N is equal to 8.

In some embodiments, a value of N is same for different values of M.

In some embodiments, at least one first block vector difference (BVD) offset for the content type of a natural content is same with at least one second BVD offset for the content type of a screen content.

In some embodiments, at least one first block vector difference (BVD) offset direction for the content type of a natural content is different from at least one second BVD offset direction for the content type of a screen content. As used herein, the term “BVD offset direction” may also be referred to as an “offset direction”.

In some embodiments, the at least one first BVD offset direction comprises at least one of: at least one horizontal direction, at least one vertical direction, or at least one diagonal direction with an angle k×π/4, K being an integer. These offset directions are shown in FIG. 18A.

In some embodiments, the at least one first BVD offset direction comprises at least one of: at least one horizontal direction, at least one vertical direction, at least one diagonal direction with an angle k×π/4, K being an integer, or at least one diagonal direction with an angle j×π/8, j being an integer. These offset directions are shown in FIG. 18B.

In some embodiments, at least one first block vector difference (BVD) offset direction for the content type of a natural content is same with at least one second BVD offset direction for the content type of a screen content.

In some embodiments, the at least one first BVD offset direction comprises at least one horizontal direction and at least one vertical direction. For example, the offset directions for both natural content and screen content may include horizontal directions and vertical directions as shown in FIG. 18C.

In some embodiments, at least one first base candidate for the content type of a natural content is different from at least one second base candidate for the content type of a screen content.

In some embodiments, the number of the at least one first base candidate is smaller than the number of the at least one second base candidate.

In some embodiments, the number of the at least one first base candidate is 3, and the number of the at least one second base candidate is 5.

In some embodiments, the number of the at least one first base candidate is larger than the number of the at least one second base candidate.

In some embodiments, the number of the at least one first base candidate is same with the number of the at least one second base candidate.

In some embodiments, the number of the at least one first base candidate is 5.

In some embodiments, the content type is indicated at one of: a sequence level, a group of pictures level, a picture level, a slice level, or a tile group level.

In some embodiments, the content type is indicated in an information unit, the information unit comprising one of: a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

In some embodiments, the information unit is determined based on a hash block hit percentage at an encoder for the conversion, and the information unit is indicated to a decoder for the conversion.

In some embodiments, the hash block hit percentage of the video unit of the video is larger than a threshold, and the content type of the video unit is a screen content, and/or the hash block hit percentage of the video unit is less than or equal to the threshold, and the content type of the video unit is a natural content.

In some embodiments, the video unit comprises one of: a video sequence, a picture, a slice, or a tile.

In some embodiments, a flag in the video unit indicates the content type, and the flag is predefined.

In some embodiments, the hash block hit percentage of a beginning frame of the video is larger than a threshold, and the content type of the video unit of the video is a screen content, and/or the hash block hit percentage of the beginning frame is less than or equal to the threshold, and the content type of the video unit is a natural content.

In some embodiments, the content type is indicated in a region containing more than one sample or pixel.

In some embodiments, the region comprises one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a subpicture.

In some embodiments, an indication flag of the content type is included in the bitstream.

In some embodiments, an indication flag of the content type is determined during the conversion.

In some embodiments, the indication flag is determined based on a coding mode of at least one neighboring block of the current video block.

In some embodiments, the coding mode comprises at least one of: an intra block copy (IBC) mode, an intra template matching prediction (IntraTMP) mode, or a further coding mode with a block vector (BV).

In some embodiments, an indication of an applying of a fractional IBC-MBVD is indicated in the bitstream.

In some embodiments, the indication comprises a flag at one of: a sequence level, a group of pictures level, a picture level, a slice level, or a tile group level.

In some embodiments, the indication comprises a flag at one of: a prediction block (PB) level, a transform block (TB) level, a coding block (CB) level, a prediction unit (PU) level, a transform unit (TU) level, a coding unit (CU) level, a virtual pipeline data unit (VPDU) level, a coding tree unit (CTU) level, or a CTU row level.

In some embodiments, whether to apply the fractional IBC-MBVD is determined based on a syntax element in the bitstream.

According to further embodiments of the present disclosure, a non-transitory computer-readable recording medium is provided. The non-transitory computer-readable recording medium stores a bitstream of a video which is generated by a method performed by an apparatus for video processing. In the method, a content type of a video unit in the video is determined. A current video block is in the video unit. An intra block copy (IBC) merge mode with block vector differences (IBC-MBVD) is applied to the current video block based on the content type. The bitstream is generated based on the applying.

According to still further embodiments of the present disclosure, a method for storing bitstream of a video is provided. In the method, a content type of a video unit in the video is determined. A current video block is in the video unit. An intra block copy (IBC) merge mode with block vector differences (IBC-MBVD) is applied to the current video block based on the content type. The bitstream is generated based on the applying. The bitstream is stored in a non-transitory computer-readable recording medium.

FIG. 21 illustrates a flowchart of a method 2100 for video processing in accordance with embodiments of the present disclosure. The method 2100 is implemented for a conversion between a current video block of a video and a bitstream of the video.

At block 2110, a prediction of the current video block is determined based on at least one first block vector difference (BVD) offset for a first direction and at least one second BVD offset for a second direction. The current video block is coded with an intra block copy (IBC) merge mode with block vector differences (IBC-MBVD). The at least one second BVD offset is different from the at least one first BVD offset, and the first direction is different from the second direction.

At block 2120, the conversion is performed based on the prediction. In some embodiments, the conversion includes encoding the current video block into the bitstream. Alternatively, or in addition, in some embodiments, the conversion includes decoding the current video block from the bitstream.

The method 2100 enables using different BVD offsets for different directions such as horizontal directions and vertical directions. In this way, the coding efficiency and/or coding effectiveness can be improved.

In some embodiments, the first direction comprises a horizontal direction, and the second direction comprises a vertical direction.

In some embodiments, the first direction comprises a first horizontal direction, and the second direction comprises a second horizontal direction opposite to the first horizontal direction.

In some embodiments, the first direction comprises a first vertical direction, and the second direction comprises a second vertical direction opposite to the first vertical direction.

In some embodiments, the at least one second BVD offset comprises a subset of the at least one first BVD offset.

In some embodiments, the at least one first BVD offset comprises a subset of the at least one second BVD offset.

In some embodiments, a first value of a largest first BVD offset of the at least one first BVD offset is smaller than a second value of a largest second BVD offset of the at least one second BVD offset.

In some embodiments, a first value of a largest first BVD offset of the at least one first BVD offset is larger than a second value of a largest second BVD offset of the at least one second BVD offset.

In some embodiments, a first BVD offset for a horizontal direction is the same with a second BVD offset for a vertical direction.

According to further embodiments of the present disclosure, a non-transitory computer-readable recording medium is provided. The non-transitory computer-readable recording medium stores a bitstream of a video which is generated by a method performed by an apparatus for video processing. In the method, a prediction of a current video block of the video is determined based on at least one first block vector difference (BVD) offset for a first direction and at least one second BVD offset for a second direction. The current video block is coded with an intra block copy (IBC) merge mode with block vector differences (IBC-MBVD). The at least one second BVD offset is different from the at least one first BVD offset, and the first direction is different from the second direction. The bitstream is generated based on the prediction.

According to still further embodiments of the present disclosure, a method for storing bitstream of a video is provided. In the method, a prediction of a current video block of the video is determined based on at least one first block vector difference (BVD) offset for a first direction and at least one second BVD offset for a second direction. The current video block is coded with an intra block copy (IBC) merge mode with block vector differences (IBC-MBVD). The at least one second BVD offset is different from the at least one first BVD offset, and the first direction is different from the second direction. The bitstream is generated based on the prediction. The bitstream is stored in a non-transitory computer-readable recording medium.

In some embodiments, an indication or a syntax element in the bitstream is binarized as at least one of: a flag, a fixed length code, an exponential Golomb (EG) (x) code, a unary code, a truncated unary code, or a truncated binary code.

In some embodiments, the indication or the syntax element is signed or unsigned.

In some embodiments, an indication or a syntax element in the bitstream is coded with at least one context model, or bypass coded.

In some embodiments, the indication or the syntax element is included in the bitstream based on a condition.

In some embodiments, the condition comprises that a function associated with the indication or the syntax element is applicable.

In some embodiments, the indication or the syntax element is at at least one of: a block level, a sequence level, a group of pictures level, a picture level, a slice level, or a tile group level.

In some embodiments, the indication or the syntax element is in a coding structure, the coding structure comprising at least one of: a coding tree unit (CTU), a coding unit (CU), a transform unit (TU), a prediction unit (PU), a coding tree block (CTB), a coding block (CB), a transform block (TB), a prediction block (PB), a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

In some embodiments, the current video block comprises one of: a color component, a sub-picture, a slice, a tile, a coding tree unit (CTU), a CTU row, groups of CTUs a coding unit (CU), a prediction unit (PU), a transform unit (TU), a coding tree block (CTB), a coding block (CB), a prediction block (PB), a transform block (TB), a block, a sub-block of a block, a sub-region within a block, or a region that contains more than one sample or pixel.

In some embodiments, information regarding whether to and/or how to apply the method 1900, the method 2000, and/or the method 2100 is included in the bitstream.

In some embodiments, the information is indicated at one of: a sequence level, a group of pictures level, a picture level, a slice level or a tile group level.

In some embodiments, the information is indicated in a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

In some embodiments, the information is indicated in a region containing more than one sample or pixel.

In some embodiments, the region comprises one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a subpicture.

In some embodiments, the information is based on coded information.

In some embodiments, the coded information comprises at least one of: a coding mode, a block size, a color format, a single or dual tree partitioning, a color component, a slice type, or a picture type.

It is to be understood that the method 1900, the method 2000 and/or the method 2100 can be applied separately, or in any combination. With the method 2000 and/or the method 2100, the coding effectiveness and/or the coding efficiency can be improved.

Implementations of the present disclosure can be described in view of the following clauses, the features of which can be combined in any reasonable manner.

Clause 1. A method for video processing, comprising: applying, for a conversion between a current video block of a video and a bitstream of the video, a process to the current video block based on template matching, wherein at least one reference sample of a current template of the current video block is determined based on a block vector (BV) of the current video block during the process; and performing the conversion based on the applying.

Clause 2. The method of clause 1, wherein the process comprises at least one of: a reordering process, a refinement process, a searching process, or a local illumination compensation (LIC) process.

Clause 3. The method of clause 1 or 2, wherein the BV of the current video block is in a fractional-pel precision, and the at least one reference sample is determined by an interpolation filter with N-tap, N being an integer larger than one.

Clause 4. The method of clause 3, wherein N comprises one of: 2, 4, 6, 8, 10 or 12.

Clause 5. The method of clause 3, wherein the interpolation filter comprises a bilinear interpolation filter.

Clause 6. The method of any of clauses 1-5, wherein the process comprises a template matching reordering process for at least one of: a regular intra block copy (IBC) merge candidate list, an IBC advanced motion vector prediction (AMVP) candidate list, an IBC template matching (IBC-TM) merge candidate list, an IBC-TM AMVP candidate list, an IBC merge mode with block vector differences (IBC-MBVD) base candidate list, an IBC-MBVD candidate list, an IBC merge candidate list used in IBC combined intra and inter prediction mode (CIIP), a regular IBC merge candidate list or IBC-TM merge candidate list used in IBC geometric partitioning mode (GPM), a block vector difference (BVD) sign prediction for IBC AMVP mode, a BVD sign prediction for IBC-MBVD mode, a BVD magnitude suffix bins prediction for IBC AMVP mode, a BVD magnitude suffix bins prediction for IBC-MBVD mode, a multi-candidate list construction of intra template matching prediction (IntraTMP), or a further template matching reordering for a block with a BV.

Clause 7. The method of any of clauses 1-6, wherein the process comprises at least one of: a template matching refinement for intra block copy (IBC) template matching (TM) merge, a template matching refinement for IBC-TM advanced motion vector prediction (AMVP), or a further template matching refinement for a block with a BV.

Clause 8. The method of any of clauses 1-7, wherein the process comprises at least one of: a template matching searching for intra template matching prediction (IntraTMP), or a further template matching searching for a block with a BV.

Clause 9. The method of any of clauses 1-8, wherein the process comprises an intra block copy (IBC) local illumination compensation (LIC) process.

Clause 10. The method of any of clauses 1-9, wherein the block is coded with at least one of: an intra block copy (IBC) mode, or an intra template matching prediction (IntraTMP) mode.

Clause 11. The method of clause 1 or 2, wherein the BV of the current video block is in a fractional-pel precision, and wherein the method further comprises: updating the BV to an integer-pel precision, the at least one reference sample of the current template being determined based on the updated BV without using an interpolation filter.

Clause 12. The method of clause 11, wherein the BV is updated by a rounding up or a rounding down to the integer-pel precision.

Clause 13. The method of clause 11 or 12, wherein a plurality of BVs in a plurality of directions is updated by a plurality of rounding operations, the plurality of rounding operations comprises at least one of: a rounding up, a rounding down, or a rounding to a nearest integer.

Clause 14. A method for video processing, comprising: determining, for a conversion between a current video block of a video and a bitstream of the video, a content type of a video unit in the video, the current video block being in the video unit; applying an intra block copy (IBC) merge mode with block vector differences (IBC-MBVD) to the current video block based on the content type; and performing the conversion based on the applying.

Clause 15. The method of clause 14, wherein the content type of the video comprises one of: a natural content, or a screen content.

Clause 16. The method of clause 14 or 15, wherein at least one first block vector difference (BVD) offset for the content type of a natural content is different from at least one second BVD offset for the content type of a screen content.

Clause 17. The method of clause 16, wherein the at least one first BVD offset is determined by multiplying the at least one second BVD offset by a factor.

Clause 18. The method of clause 17, wherein the factor is less than one.

Clause 19. The method of clause 17 or 18, wherein the factor comprises ¼.

Clause 20. The method of clause 19, wherein the at least one second BVD offset comprises a set of {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the at least one first BVD offset comprises a set of {¼-pel, ½-pel, 1-pel, 2-pel, 3-pel, 4-pel, 6-pel, 8-pel, 10-pel, 12-pel, 14-pel, 16-pel, 18-pel, 20-pel, 22-pel, 24-pel, 26-pel, 28-pel, 30-pel, 32-pel}.

Clause 21. The method of clause 17 or 18, wherein the factor comprises ½.

Clause 22. The method of any of clauses 14-21, wherein at least one fractional-pel block vector difference (BVD) offset is applied for both a natural content and a screen content.

Clause 23. The method of any of clauses 14-21, wherein at least one fractional-pel block vector difference (BVD) offset is applied for a natural content.

Clause 24. The method of any of clauses 14-23, wherein a set of block vector difference (BVD) offsets for the IBC-MBVD comprises one of: a first set comprising ¼-pel, ½-pel, 1-pel, 2-pel, 4-pel and 8-pel, a second set comprising ½-pel, 1-pel, 2-pel, 4-pel, 8-pel and 16-pel, a third set comprising ¼-pel, ½-pel, 1-pel, 2-pel, 4-pel, 8-pel, 16-pel and 32-pel, or a fourth set comprising ¼-pel, ½-pel, 1-pel, 2-pel, 3-pel, 4-pel, 6-pel, 8-pel, 10-pel, 12-pel, 14-pel, 16-pel, 18-pel, 20-pel, 22-pel, 24-pel, 26-pel, 28-pel, 30-pel and 32-pel.

Clause 25. The method of any of clauses 14-23, wherein a set of adaptive block vector difference (BVD) offsets along at least one MBVD direction is allowed, and an interval between BVD offsets is reduced by half to a fractional-pel.

Clause 26. The method of clause 25, wherein the fractional-pel comprises one of: a ¼ pel or a ½ pel.

Clause 27. The method of clause 25 or 26, wherein applying IBC-MBVD to the current video block comprises: for each selected candidate in a set of selected candidates in an IBC-MBVD candidate list, checking template matching costs of two candidates with an offset between the two candidates, and a selected candidate being equal to M/2 and −M/2 along the selected candidate direction, M being an interval value greater than 0; and keeping candidates with lowest K template matching costs in the IBC-MBVD candidate list, K being an integer greater than or equal to 1.

Clause 28. The method of clause 27, wherein the set of selected candidates comprises top N candidates in the IBC-MBVD candidate list, N being an integer smaller than or equal to K and greater than or equal to 1.

Clause 29. The method of clause 28, wherein N comprises one of: 1, 2, 3, . . . , K−2, K−1, or K.

Clause 30. The method of any of clauses 27-29, wherein a value of N is based on a value of M.

Clause 31. The method of clause 30, wherein M is equal to 1, and N is equal to 4.

Clause 32. The method of clause 30, wherein M is equal to ½, and N is equal to 2 or 4.

Clause 33. The method of clause 30, wherein M is greater than or equal to 1 or M is greater than 1, and N is equal to 8.

Clause 34. The method of any of clauses 27-29, wherein a value of N is same for different values of M.

Clause 35. The method of clause 14 or 15, wherein at least one first block vector difference (BVD) offset for the content type of a natural content is same with at least one second BVD offset for the content type of a screen content.

Clause 36. The method of any of clauses 14-35, wherein at least one first block vector difference (BVD) offset direction for the content type of a natural content is different from at least one second BVD offset direction for the content type of a screen content.

Clause 37. The method of clause 36, wherein the at least one first BVD offset direction comprises at least one of: at least one horizontal direction, at least one vertical direction, or at least one diagonal direction with an angle k×π/4, K being an integer.

Clause 38. The method of clause 36, wherein the at least one first BVD offset direction comprises at least one of: at least one horizontal direction, at least one vertical direction, at least one diagonal direction with an angle k×π/4, K being an integer, or at least one diagonal direction with an angle j×π/8, j being an integer.

Clause 39. The method of any of clauses 14-35, wherein at least one first block vector difference (BVD) offset direction for the content type of a natural content is same with at least one second BVD offset direction for the content type of a screen content.

Clause 40. The method of clause 39, wherein the at least one first BVD offset direction comprises at least one horizontal direction and at least one vertical direction.

Clause 41. The method of any of clauses 14-40, wherein at least one first base candidate for the content type of a natural content is different from at least one second base candidate for the content type of a screen content.

Clause 42. The method of clause 41, wherein the number of the at least one first base candidate is smaller than the number of the at least one second base candidate.

Clause 43. The method of clause 41 or 42, wherein the number of the at least one first base candidate is 3, and the number of the at least one second base candidate is 5.

Clause 44. The method of clause 41, wherein the number of the at least one first base candidate is larger than the number of the at least one second base candidate.

Clause 45. The method of clause 41, wherein the number of the at least one first base candidate is same with the number of the at least one second base candidate.

Clause 46. The method of clause 45, wherein the number of the at least one first base candidate is 5.

Clause 47. The method of any of clauses 14-46, wherein the content type is indicated at one of: a sequence level, a group of pictures level, a picture level, a slice level, or a tile group level.

Clause 48. The method of any of clauses 14-47, wherein the content type is indicated in an information unit, the information unit comprising one of: a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

Clause 49. The method of clause 48, wherein the information unit is determined based on a hash block hit percentage at an encoder for the conversion, and the information unit is indicated to a decoder for the conversion.

Clause 50. The method of clause 49, wherein the hash block hit percentage of the video unit of the video is larger than a threshold, and the content type of the video unit is a screen content, and/or the hash block hit percentage of the video unit is less than or equal to the threshold, and the content type of the video unit is a natural content.

Clause 51. The method of clause 50, wherein the video unit comprises one of: a video sequence, a picture, a slice, or a tile.

Clause 52. The method of clause 50 or 51, wherein a flag in the video unit indicates the content type, and the flag is predefined.

Clause 53. The method of clause 49, wherein the hash block hit percentage of a beginning frame of the video is larger than a threshold, and the content type of the video unit of the video is a screen content, and/or the hash block hit percentage of the beginning frame is less than or equal to the threshold, and the content type of the video unit is a natural content.

Clause 54. The method of any of clauses 14-53, wherein the content type is indicated in a region containing more than one sample or pixel.

Clause 55. The method of clause 54, wherein the region comprises one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a subpicture.

Clause 56. The method of clause 54 or 55, wherein an indication flag of the content type is included in the bitstream.

Clause 57. The method of clause 54 or 55, wherein an indication flag of the content type is determined during the conversion.

Clause 58. The method of clause 57, wherein the indication flag is determined based on a coding mode of at least one neighboring block of the current video block.

Clause 59. The method of clause 58, wherein the coding mode comprises at least one of: an intra block copy (IBC) mode, an intra template matching prediction (IntraTMP) mode, or a further coding mode with a block vector (BV).

Clause 60. The method of any of clauses 14-59, wherein an indication of an applying of a fractional IBC-MBVD is indicated in the bitstream.

Clause 61. The method of clause 60, wherein the indication comprises a flag at one of: a sequence level, a group of pictures level, a picture level, a slice level, or a tile group level.

Clause 62. The method of clause 60, wherein the indication comprises a flag at one of: a prediction block (PB) level, a transform block (TB) level, a coding block (CB) level, a prediction unit (PU) level, a transform unit (TU) level, a coding unit (CU) level, a virtual pipeline data unit (VPDU) level, a coding tree unit (CTU) level, or a CTU row level.

Clause 63. The method of clause 60, wherein whether to apply the fractional IBC-MBVD is determined based on a syntax element in the bitstream.

Clause 64. A method for video processing, comprising: determining, for a conversion between a current video block of a video and a bitstream of the video, a prediction of the current video block based on at least one first block vector difference (BVD) offset for a first direction and at least one second BVD offset for a second direction, the current video block being coded with an intra block copy (IBC) merge mode with block vector differences (IBC-MBVD), the at least one second BVD offset being different from the at least one first BVD offset, and the first direction being different from the second direction; and performing the conversion based on the prediction.

Clause 65. The method of clause 64, wherein the first direction comprises a horizontal direction, and the second direction comprises a vertical direction.

Clause 66. The method of clause 64, wherein the first direction comprises a first horizontal direction, and the second direction comprises a second horizontal direction opposite to the first horizontal direction.

Clause 67. The method of clause 64, wherein the first direction comprises a first vertical direction, and the second direction comprises a second vertical direction opposite to the first vertical direction.

Clause 68. The method of any of clauses 64-67, wherein the at least one second BVD offset comprises a subset of the at least one first BVD offset.

Clause 69. The method of any of clauses 64-67, wherein the at least one first BVD offset comprises a subset of the at least one second BVD offset.

Clause 70. The method of any of clauses 64-69, wherein a first value of a largest first BVD offset of the at least one first BVD offset is smaller than a second value of a largest second BVD offset of the at least one second BVD offset.

Clause 71. The method of any of clauses 64-69, wherein a first value of a largest first BVD offset of the at least one first BVD offset is larger than a second value of a largest second BVD offset of the at least one second BVD offset.

Clause 72. The method of clause 64, wherein a first BVD offset for a horizontal direction is the same with a second BVD offset for a vertical direction.

Clause 73. The method of any of clauses 1-72, wherein an indication or a syntax element in the bitstream is binarized as at least one of: a flag, a fixed length code, an exponential Golomb (EG) (x) code, a unary code, a truncated unary code, or a truncated binary code.

Clause 74. The method of clause 73, wherein the indication or the syntax element is signed or unsigned.

Clause 75. The method of any of clauses 1-74, wherein an indication or a syntax element in the bitstream is coded with at least one context model, or bypass coded.

Clause 76. The method of any of clauses 73-75, wherein the indication or the syntax element is included in the bitstream based on a condition.

Clause 77. The method of clause 76, wherein the condition comprises that a function associated with the indication or the syntax element is applicable.

Clause 78. The method of any of clauses 73-77, wherein the indication or the syntax element is at at least one of: a block level, a sequence level, a group of pictures level, a picture level, a slice level, or a tile group level.

Clause 79. The method of any of clauses 73-78, wherein the indication or the syntax element is in a coding structure, the coding structure comprising at least one of: a coding tree unit (CTU), a coding unit (CU), a transform unit (TU), a prediction unit (PU), a coding tree block (CTB), a coding block (CB), a transform block (TB), a prediction block (PB), a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

Clause 80. The method of any of clauses 1-79, wherein the current video block comprises one of: a color component, a sub-picture, a slice, a tile, a coding tree unit (CTU), a CTU row, groups of CTUs a coding unit (CU), a prediction unit (PU), a transform unit (TU), a coding tree block (CTB), a coding block (CB), a prediction block (PB), a transform block (TB), a block, a sub-block of a block, a sub-region within a block, or a region that contains more than one sample or pixel.

Clause 81. The method of any of clauses 1-80, wherein information regarding whether to and/or how to apply the method is included in the bitstream.

Clause 82. The method of clause 81, wherein the information is indicated at one of: a sequence level, a group of pictures level, a picture level, a slice level or a tile group level.

Clause 83. The method of clause 81 or clause 82, wherein the information is indicated in a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

Clause 84. The method of any of clauses 81-83, wherein the information is indicated in a region containing more than one sample or pixel.

Clause 85. The method of clause 84, wherein the region comprises one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a subpicture.

Clause 86. The method of any of clauses 81-85, wherein the information is based on coded information.

Clause 87. The method of clause 86, wherein the coded information comprises at least one of: a coding mode, a block size, a color format, a single or dual tree partitioning, a color component, a slice type, or a picture type.

Clause 88. The method of any of clauses 1-87, wherein the conversion includes encoding the current video block into the bitstream.

Clause 89. The method of any of clauses 1-87, wherein the conversion includes decoding the current video block from the bitstream.

Clause 90. An apparatus for video processing comprising a processor and a non-transitory memory with instructions thereon, wherein the instructions upon execution by the processor, cause the processor to perform a method in accordance with any of clauses 1-89.

Clause 91. A non-transitory computer-readable storage medium storing instructions that cause a processor to perform a method in accordance with any of clauses 1-89.

Clause 92. A non-transitory computer-readable recording medium storing a bitstream of a video which is generated by a method performed by an apparatus for video processing, wherein the method comprises: applying a process to a current video block of the video based on template matching, wherein at least one reference sample of a current template of the current video block is determined based on a block vector (BV) of the current video block during the process; and generating the bitstream based on the applying.

Clause 93. A method for storing a bitstream of a video, comprising: applying a process to a current video block of the video based on template matching, wherein at least one reference sample of a current template of the current video block is determined based on a block vector (BV) of the current video block during the process; generating the bitstream based on the applying; and storing the bitstream in a non-transitory computer-readable recording medium.

Clause 94. A non-transitory computer-readable recording medium storing a bitstream of a video which is generated by a method performed by an apparatus for video processing, wherein the method comprises: determining a content type of a video unit in the video, a current video block being in the video unit; applying an intra block copy (IBC) merge mode with block vector differences (IBC-MBVD) to the current video block based on the content type; and generating the bitstream based on the applying.

Clause 95. A method for storing a bitstream of a video, comprising: determining a content type of a video unit in the video, a current video block being in the video unit; applying an intra block copy (IBC) merge mode with block vector differences (IBC-MBVD) to the current video block based on the content type; generating the bitstream based on the applying; and storing the bitstream in a non-transitory computer-readable recording medium.

Clause 96. A non-transitory computer-readable recording medium storing a bitstream of a video which is generated by a method performed by an apparatus for video processing, wherein the method comprises: determining a prediction of a current video block of the video based on at least one first block vector difference (BVD) offset for a first direction and at least one second BVD offset for a second direction, the current video block being coded with an intra block copy (IBC) merge mode with block vector differences (IBC-MBVD), the at least one second BVD offset being different from the at least one first BVD offset, and the first direction being different from the second direction; and generating the bitstream based on the prediction.

Clause 97. A method for storing a bitstream of a video, comprising: determining a prediction of a current video block of the video based on at least one first block vector difference (BVD) offset for a first direction and at least one second BVD offset for a second direction, the current video block being coded with an intra block copy (IBC) merge mode with block vector differences (IBC-MBVD), the at least one second BVD offset being different from the at least one first BVD offset, and the first direction being different from the second direction; generating the bitstream based on the prediction; and storing the bitstream in a non-transitory computer-readable recording medium.

### Example Device

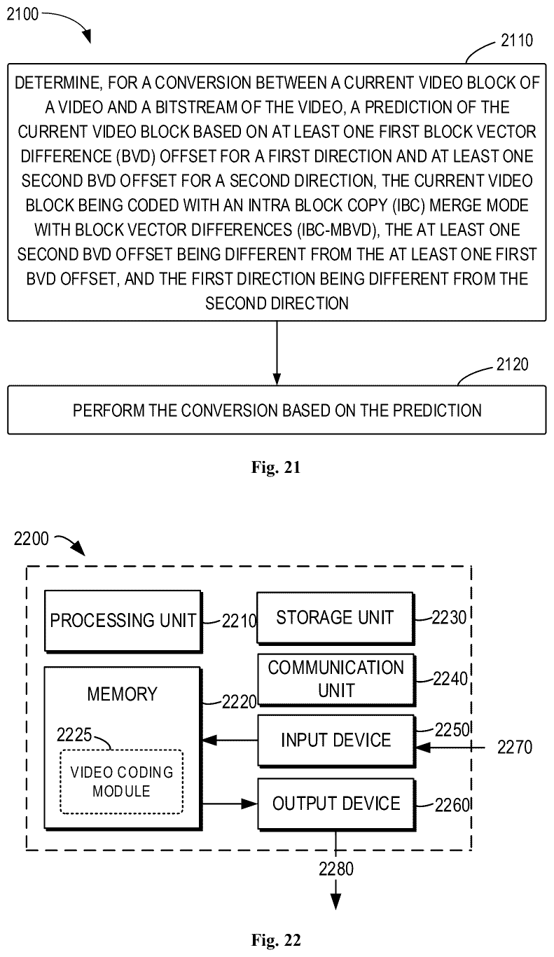

FIG. 22 illustrates a block diagram of a computing device 2200 in which various embodiments of the present disclosure can be implemented. The computing device 2200 may be implemented as or included in the source device 110 (or the video encoder 114 or 200) or the destination device 120 (or the video decoder 124 or 300).

It would be appreciated that the computing device 2200 shown in FIG. 22 is merely for purpose of illustration, without suggesting any limitation to the functions and scopes of the embodiments of the present disclosure in any manner.

As shown in FIG. 22, the computing device 2200 includes a general-purpose computing device 2200. The computing device 2200 may at least comprise one or more processors or processing units 2210, a memory 2220, a storage unit 2230, one or more communication units 2240, one or more input devices 2250, and one or more output devices 2260.

In some embodiments, the computing device 2200 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2200 can support any type of interface to a user (such as “wearable” circuitry and the like).

The processing unit 2210 may be a physical or virtual processor and can implement various processes based on programs stored in the memory 2220. In a multi-processor system, multiple processing units execute computer executable instructions in parallel so as to improve the parallel processing capability of the computing device 2200. The processing unit 2210 may also be referred to as a central processing unit (CPU), a microprocessor, a controller or a microcontroller.

The computing device 2200 typically includes various computer storage medium. Such medium can be any medium accessible by the computing device 2200, including, but not limited to, volatile and non-volatile medium, or detachable and non-detachable medium. The memory 2220 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2230 may be any detachable or non-detachable medium and may include a machine-readable medium such as a memory, flash memory drive, magnetic disk or another other media, which can be used for storing information and/or data and can be accessed in the computing device 2200.

The computing device 2200 may further include additional detachable/non-detachable, volatile/non-volatile memory medium. Although not shown in FIG. 22, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2240 communicates with a further computing device via the communication medium. In addition, the functions of the components in the computing device 2200 can be implemented by a single computing cluster or multiple computing machines that can communicate via communication connections. Therefore, the computing device 2200 can operate in a networked environment using a logical connection with one or more other servers, networked personal computers (PCs) or further general network nodes.

The input device 2250 may be one or more of a variety of input devices, such as a mouse, keyboard, tracking ball, voice-input device, and the like. The output device 2260 may be one or more of a variety of output devices, such as a display, loudspeaker, printer, and the like. By means of the communication unit 2240, the computing device 2200 can further communicate with one or more external devices (not shown) such as the storage devices and display device, with one or more devices enabling the user to interact with the computing device 2200, or any devices (such as a network card, a modem and the like) enabling the computing device 2200 to communicate with one or more other computing devices, if required. Such communication can be performed via input/output (I/O) interfaces (not shown).

In some embodiments, instead of being integrated in a single device, some or all components of the computing device 2200 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2200 may be used to implement video encoding/decoding in embodiments of the present disclosure. The memory 2220 may include one or more video coding modules 2225 having one or more program instructions. These modules are accessible and executable by the processing unit 2210 to perform the functionalities of the various embodiments described herein.

In the example embodiments of performing video encoding, the input device 2250 may receive video data as an input 2270 to be encoded. The video data may be processed, for example, by the video coding module 2225, to generate an encoded bitstream. The encoded bitstream may be provided via the output device 2260 as an output 2280.

In the example embodiments of performing video decoding, the input device 2250 may receive an encoded bitstream as the input 2270. The encoded bitstream may be processed, for example, by the video coding module 2225, to generate decoded video data. The decoded video data may be provided via the output device 2260 as the output 2280.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

What is claimed is:

1. A method for video processing, comprising:
applying, for a conversion between a current video block of a video and a bitstream of the video, a process to the current video block based on template matching, wherein at least one reference sample of a current template of the current video block is determined based on a block vector (BV) of the current video block during the process; and
performing the conversion based on the applying.

2. The method of claim 1, wherein the process comprises at least one of:
a reordering process,
a refinement process,
a searching process, or
a local illumination compensation (LIC) process.

3. The method of claim 1, wherein the BV of the current video block is in a fractional-pel precision, and the at least one reference sample is determined by an interpolation filter with N-tap, N being an integer larger than one.

4. The method of claim 3, wherein N comprises one of: 2, 4, 6, 8, 10 or 12.

5. The method of claim 3, wherein the interpolation filter comprises a bilinear interpolation filter.

6. The method of claim 1, wherein the process comprises a template matching reordering process for at least one of:
a regular intra block copy (IBC) merge candidate list,
an IBC advanced motion vector prediction (AMVP) candidate list,
an IBC template matching (IBC-TM) merge candidate list,
an IBC-TM AMVP candidate list,
an IBC merge mode with block vector differences (IBC-MBVD) base candidate list,
an IBC-MBVD candidate list,
an IBC merge candidate list used in IBC combined intra and inter prediction mode (CIIP),
a regular IBC merge candidate list or IBC-TM merge candidate list used in IBC geometric partitioning mode (GPM),
a block vector difference (BVD) sign prediction for IBC AMVP mode,
a BVD sign prediction for IBC-MBVD mode,
a BVD magnitude suffix bins prediction for IBC AMVP mode,
a BVD magnitude suffix bins prediction for IBC-MBVD mode,
a multi-candidate list construction of intra template matching prediction (IntraTMP), or
a further template matching reordering for a block with a BV.

7. The method of claim 1, wherein the process comprises at least one of:
a template matching refinement for intra block copy (IBC) template matching (TM) merge,
a template matching refinement for IBC-TM advanced motion vector prediction (AMVP), or
a further template matching refinement for a block with a BV.

8. The method of claim 1, wherein the process comprises at least one of:
a template matching searching for intra template matching prediction (IntraTMP), or
a further template matching searching for a block with a BV.

9. The method of claim 1, wherein the process comprises an intra block copy (IBC) local illumination compensation (LIC) process.

10. The method of claim 1, wherein the block is coded with at least one of: an intra block copy (IBC) mode, or an intra template matching prediction (IntraTMP) mode.

11. The method of claim 1, wherein the BV of the current video block is in a fractional-pel precision, and wherein the method further comprises:
updating the BV to an integer-pel precision, the at least one reference sample of the current template being determined based on the updated BV without using an interpolation filter.

12. The method of claim 11, wherein the BV is updated by a rounding up or a rounding down to the integer-pel precision.

13. The method of claim 11, wherein a plurality of BVs in a plurality of directions is updated by a plurality of rounding operations, the plurality of rounding operations comprises at least one of: a rounding up, a rounding down, or a rounding to a nearest integer.

14. The method of claim 1, wherein the conversion includes encoding the current video block into the bitstream.

15. The method of claim 1, wherein the conversion includes decoding the current video block from the bitstream.

16. An apparatus for video processing comprising a processor and a non-transitory memory with instructions thereon, wherein the instructions upon execution by the processor, cause the processor to:
apply, for a conversion between a current video block of a video and a bitstream of the video, a process to the current video block based on template matching, wherein at least one reference sample of a current template of the current video block is determined based on a block vector (BV) of the current video block during the process; and
perform the conversion based on the applying of the process.

17. The apparatus of claim 16, wherein the process comprises at least one of:
a reordering process,
a refinement process,
a searching process, or
a local illumination compensation (LIC) process.

18. A non-transitory computer-readable storage medium storing instructions that cause a processor to perform acts comprising:
applying, for a conversion between a current video block of a video and a bitstream of the video, a process to the current video block based on template matching, wherein at least one reference sample of a current template of the current video block is determined based on a block vector (BV) of the current video block during the process; and
performing the conversion based on the applying.

19. The non-transitory computer-readable storage medium of claim 18, wherein the process comprises at least one of:
a reordering process,
a refinement process,
a searching process, or
a local illumination compensation (LIC) process.

20. A non-transitory computer-readable recording medium storing a bitstream of a video which is generated by a method performed by an apparatus for video processing, wherein the method comprises:
applying a process to a current video block of the video based on template matching, wherein at least one reference sample of a current template of the current video block is determined based on a block vector (BV) of the current video block during the process; and
generating the bitstream based on the applying.
